(19) United States
(12) Patent Application Publication
(10) Pub. No.: US 2013/0041707 A1
(43) Pub. Date: Feb. 14, 2013

(54) APPARATUSES, METHODS AND SYSTEMS FOR AN INCREMENTAL CONTAINER USER INTERFACE WORKFLOW OPTIMIZER

(71) Applicants: Subhra Bose, Ossining, NY (US); Nitesh Ambastha, Greenwich, CT (US); Paul Stirpe, Shoreham, NY (US); Hua Ding, NY, NY (US); Meredith Moss, Brooklyn, NY (US)

(72) Inventors: Subhra Bose, Ossining, NY (US); Nitesh Ambastha, Greenwich, CT (US); Paul Stirpe, Shoreham, NY (US); Hua Ding, NY, NY (US); Meredith Moss, Brooklyn, NY (US)

(21) Appl. No.: 13/367,611

(22) Filed: Feb. 7, 2012

Related U.S. Application Data
(63) Continuation of application No. 13/166,766, filed on Jun. 22, 2011, now abandoned.
Application No. 13/166,766 is a continuation of application No. 12/940,997, filed on Nov. 5, 2010, now abandoned.
(60) Provisional application No. 61/258,579, filed on Nov. 5, 2009.

(51) Int. Cl. G06Q 10/06; G06Q 40/06

(52) U.S. Cl. 705/7.15; 705/36 R

(57) ABSTRACT

The APPARATUSES, METHODS AND SYSTEMS FOR AN INCREMENTAL CONTAINER USER INTERFACE WORKFLOW OPTIMIZER (“WORKFLOW OPTIMIZER”) transforms user action request input via various WORKFLOW OPTIMIZER components into updated incremental container user interface output. In one embodiment, the WORKFLOW OPTIMIZER allows management of active/passive portfolios, integrates with trading desks/brokers, and guides portfolio managers through the trading workflow. Once the WORKFLOW OPTIMIZER receives an indication of a user's progress in a workflow, it determines a workflow sub-flow currently relevant to the user. The WORKFLOW OPTIMIZER also determines sequential actions sufficient to complete the current sub-flow, and relevant actions that are applicable to the current sub-flow that are not sequential actions. Based on this information, the WORKFLOW OPTIMIZER displays an incremental container user interface having a first part comprising user interface components in a sequential order corresponding to sequential actions, and a second part comprising user interface components corresponding to relevant actions.

### RELATED APPLICATIONS

This is a continuation of and claims priority under 35 U.S.C. §120 to U.S. patent application Ser. No. 13/166,766, filed Jun. 22, 2011, entitled “APPARATUSES, METHODS AND SYSTEMS FOR AN INCREMENTAL CONTAINER USER INTERFACE WORKFLOW OPTIMIZER,” attorney docket no. 18034-009CT1, which is a continuation of and claims priority under 35 U.S.C. §120 to U.S. patent application Ser. No. 12/940,997, filed Nov. 5, 2010, entitled “APPARATUSES, METHODS AND SYSTEMS FOR AN INCREMENTAL CONTAINER USER INTERFACE WORKFLOW OPTIMIZER,” attorney docket no. 18034-009US, which claims priority under 35 U.S.C. §119 to U.S. provisional patent application Ser. No. 61/258,579, filed Nov. 5, 2009, entitled “APPARATUSES, METHODS AND SYSTEMS FOR AN INCREMENTAL CONTAINER USER INTERFACE WORKFLOW OPTIMIZER,” attorney docket no. 18034-009PV.

The entire contents of the aforementioned applications are herein expressly incorporated by reference.

### FIELD

The present invention is directed generally to an apparatuses, methods, and systems of Data Management, and more particularly, to APPARATUSES, METHODS AND SYSTEMS FOR AN INCREMENTAL CONTAINER USER INTERFACE WORKFLOW OPTIMIZER.

### BACKGROUND

Portfolio managers are tasked with managing portfolios of investments to maximize returns at a given level of risk. Portfolio management usually involves obtaining information from a diversity of sources from which portfolio managers can make decisions to further a financial goal.

### SUMMARY

The APPARATUSES, METHODS AND SYSTEMS FOR AN INCREMENTAL CONTAINER USER INTERFACE WORKFLOW OPTIMIZER (hereinafter “WORKFLOW OPTIMIZER”) transforms user action request input via various WORKFLOW OPTIMIZER components into updated incremental container user interface output.

In one embodiment, the WORKFLOW OPTIMIZER provides a platform that facilitates highly efficient industrial production of tailored client portfolios, and allows management of active and passive portfolios, integrates with trading desks/brokers, and guides portfolio managers through the entire trading workflow. Once the WORKFLOW OPTIMIZER receives an indication of a user's progress in an overall workflow, it determines a workflow sub-flow currently relevant to the user. The WORKFLOW OPTIMIZER also determines global sequential actions sufficient to complete the current workflow sub-flow, and relevant actions that are applicable to the current workflow sub-flow and that are not necessarily sequential actions. Based on this information, the WORKFLOW OPTIMIZER displays an incremental container user interface having a first part comprising user interface components in a sequential order corresponding to the sequential actions, and a second part comprising user interface components corresponding to the relevant actions.

### BRIEF DESCRIPTION OF THE DRAWINGS

The accompanying appendices and/or drawings illustrate various non-limiting, example, inventive aspects in accordance with the present disclosure:

FIGS. 1A-1C show a screen shot diagram illustrating workflow optimizer client user interface in one embodiment of the WORKFLOW OPTIMIZER;

FIG. 2 is of a logic flow diagram illustrating updating of the incremental container user interface based on user progress in one embodiment of the WORKFLOW OPTIMIZER;

FIG. 3 illustrates data flow in one embodiment of the WORKFLOW OPTIMIZER;

FIGS. 4A and 4B show a block diagram illustrating user workflow in one embodiment of the WORKFLOW OPTIMIZER;

FIGS. 5A and 5B show a block diagram illustrating workflow optimizer environment in one embodiment of the WORKFLOW OPTIMIZER;

FIGS. 6A and 6B show a block diagram illustrating workflow optimizer notifications and communications in one embodiment of the WORKFLOW OPTIMIZER;

FIGS. 7A and 7B show a block diagram illustrating client architecture in one embodiment of the WORKFLOW OPTIMIZER;

FIGS. 8A and 8B show a block diagram illustrating client modules communication in one embodiment of the WORKFLOW OPTIMIZER;

FIG. 9 is of a logic flow diagram illustrating a basket validation component in one embodiment of the WORKFLOW OPTIMIZER;

FIG. 10 is of a logic flow diagram illustrating a pre-trade component in one embodiment of the WORKFLOW OPTIMIZER;

FIGS. 11A and 11B show a diagram illustrating high performance analytics update logic in one embodiment of the WORKFLOW OPTIMIZER;

FIG. 12 is of a logic flow diagram illustrating a RFQ and broker selection component in one embodiment of the WORKFLOW OPTIMIZER;

FIG. 13 is of a logic flow diagram illustrating a basket execution component in one embodiment of the WORKFLOW OPTIMIZER;

FIG. 14 is of a logic flow diagram illustrating a post-trade component in one embodiment of the WORKFLOW OPTIMIZER; and

FIG. 15 is of a screen shot diagram illustrating user interface ribbons in one embodiment of the WORKFLOW OPTIMIZER;

FIG. 16 is of a block diagram illustrating a hierarchical state machine in one embodiment of the WORKFLOW OPTIMIZER;

FIG. 17 is of a screen shot diagram illustrating a workflow optimizer RFQ definition in one embodiment of the WORKFLOW OPTIMIZER;

FIGS. 18A-C show a screen shot diagram illustrating uploading a basket in one embodiment of the WORKFLOW OPTIMIZER;

FIGS. 19A and 19B show a screen shot diagram illustrating maintaining quote data in one embodiment of the WORKFLOW OPTIMIZER;

FIG. 20 is of a block diagram illustrating embodiments of the WORKFLOW OPTIMIZER controller;

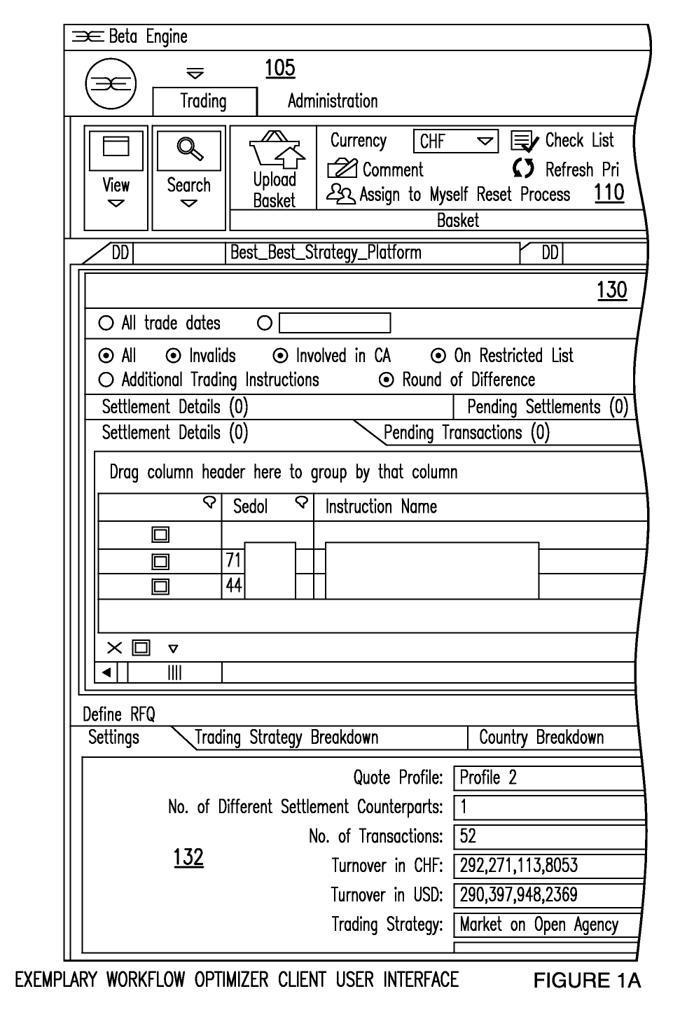

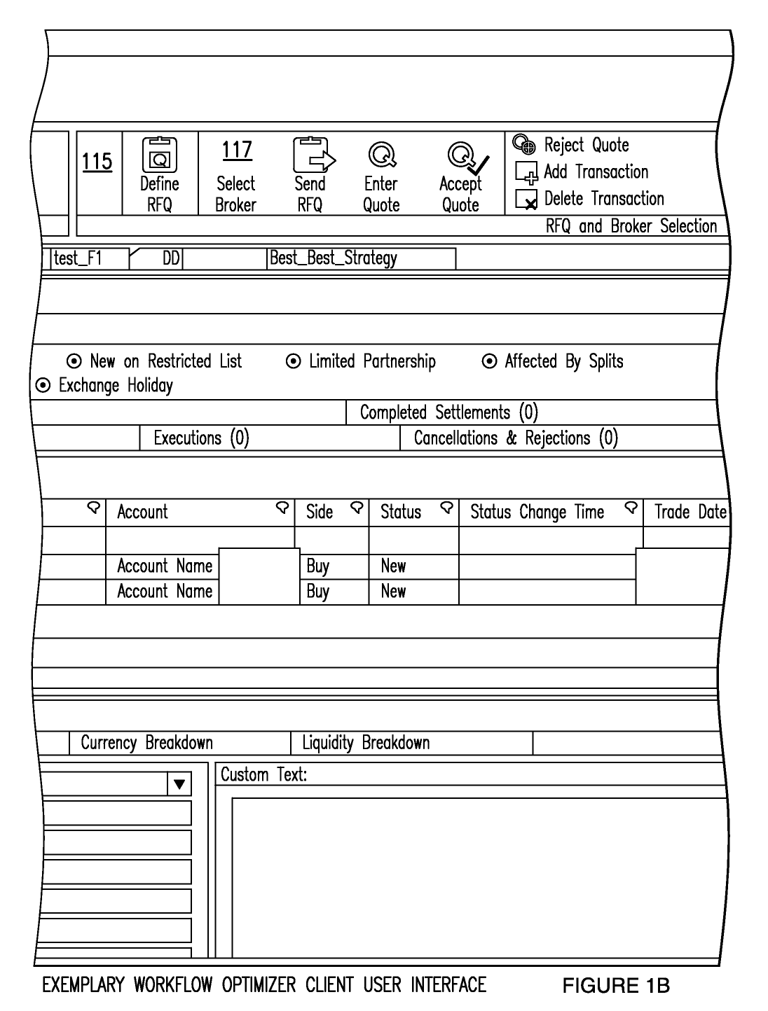

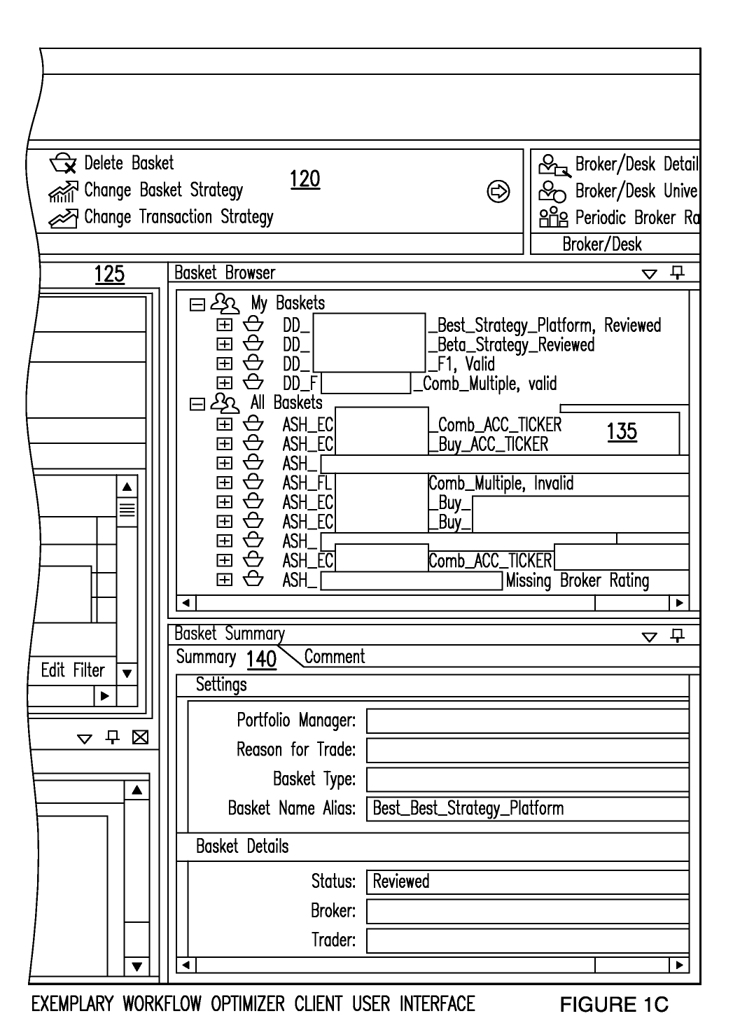

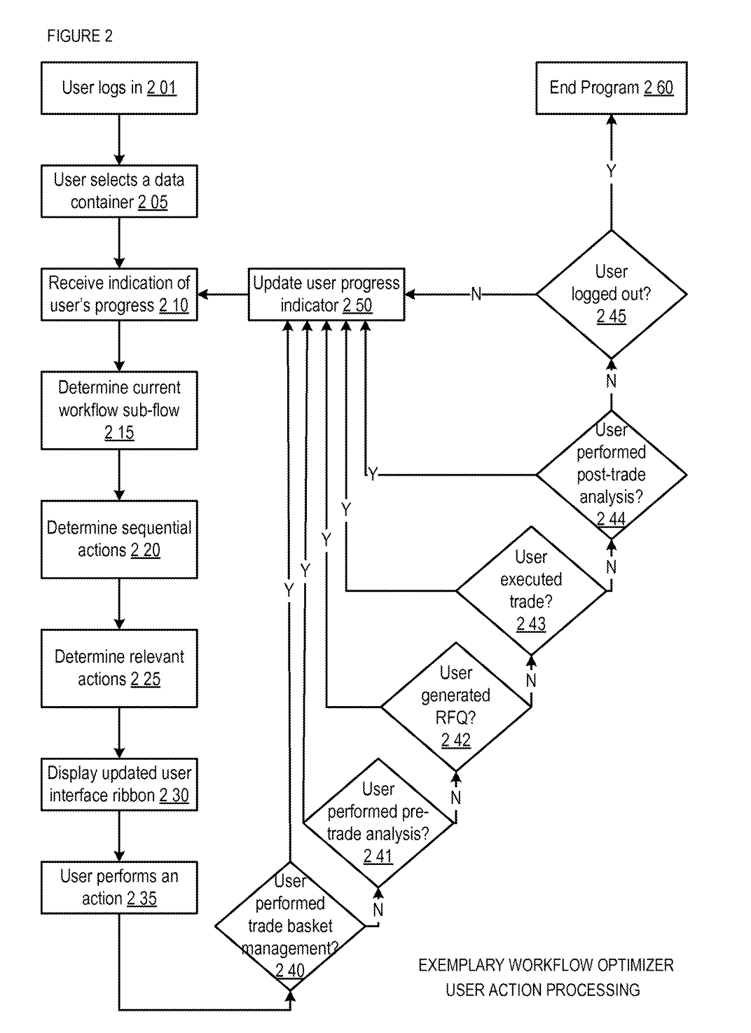

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### WORKFLOW OPTIMIZER

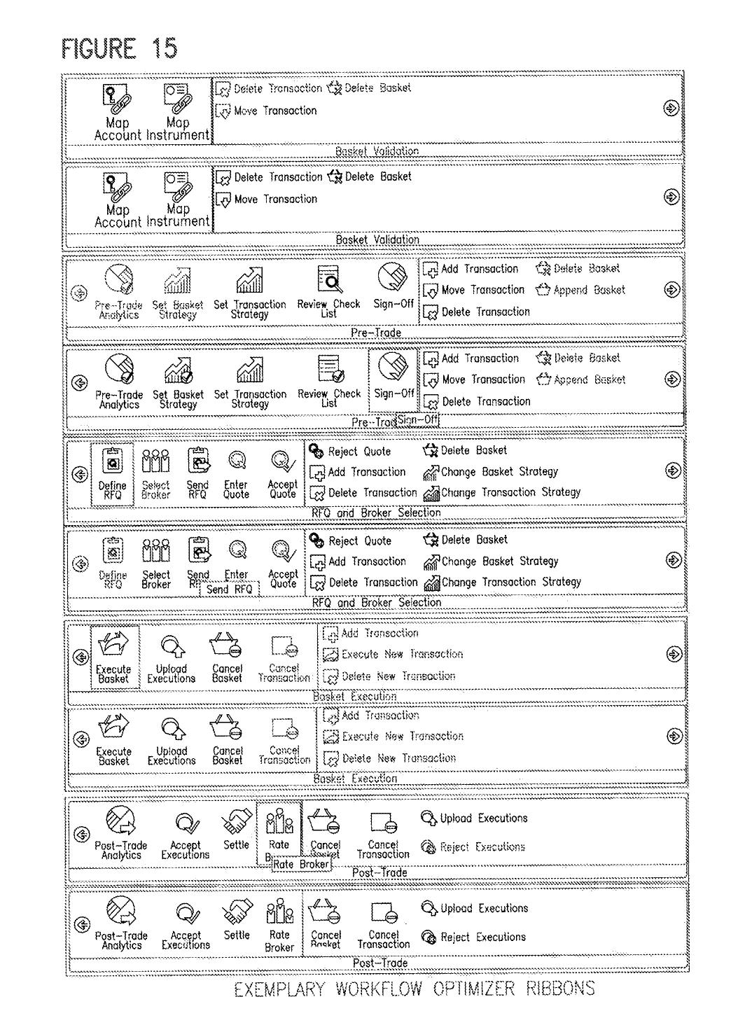

Various tools have been created to help portfolio managers keep track of their investments. However, none of them intuitively guide a user to optimize the portfolio management process. The WORKFLOW OPTIMIZER uses information regarding the user's progress to modify the user interface by presenting various incremental container user interfaces. In one embodiment, incremental container user interfaces may be user interface ribbons. These dynamic user interface ribbons help guide the user through the trading process. See FIG. 15 for illustrative examples of user interface ribbons.

Although the WORKFLOW OPTIMIZER is described with regard to portfolio management, it is to be understood that the WORKFLOW OPTIMIZER may be used in a wide variety of settings. For example, the WORKFLOW OPTIMIZER may be used as a training tool (e.g., to train portfolio managers regarding the portfolio management process). In another example, the WORKFLOW OPTIMIZER may be used for other applications, such as credit card application processing, loan processing, and/or the like. In addition, the WORKFLOW OPTIMIZER may be used to track workflow and/or sub-flow states and send out alerts (e.g., via email) under certain conditions (e.g., predefined by a system administrator), to keep an audit of user activities through the workflow and/or sub-flows (e.g., in a log file), and/or the like. Furthermore, the WORKFLOW OPTIMIZER may be used to facilitate workflows involving multiple users (e.g., to perform activities to close a deal that involve back and forth actions by multiple users).

The WORKFLOW OPTIMIZER facilitates the input and management of portfolio management data from a diversity of sources. The WORKFLOW OPTIMIZER provides various incremental container user interfaces that guide the user, in a substantially ordered manner, through a complex, time-intensive, error-prone process that requires the user to access portfolio management data via multiple screens. The WORKFLOW OPTIMIZER provides a faster, more efficient process for recalculating investment performance metrics every time a basket and/or sub-basket of investments are modified to better track investment objectives, thereby facilitating and accelerating the decision-making process. Also, the WORKFLOW OPTIMIZER assists portfolio managers in managing a larger volume of portfolios efficiently while simultaneously reducing avoidable errors and delay in the portfolio management process.

FIGS. 1A, 1B, and 1C show a screen shot diagram illustrating workflow optimizer client user interface in one embodiment of the WORKFLOW OPTIMIZER. In FIG. 1, the main window 105 (e.g., shell) of the workflow optimizer client contains user interface elements of the WORKFLOW OPTIMIZER. The ribbon 110, includes sequential actions 115 and relevant actions 120 associated with the RFQ and Broker Selection workflow sub-flow 125. In one embodiment, user interface elements 130, 132, 135, and 140 may vary depending on the current sub-flow and/or the actions performed by the user with regard to the sub-flow. For example, in FIGS. 1A-1C, the next sequential action the user may perform is to define a request for quotation (RFQ). In one implementation, user interface element 130, which may display transaction information associated with a basket, may be presented to the user to facilitate defining a RFQ and/or to aid in broker selection. In one implementation, the basket browser 135 may be presented to the user, which may facilitate viewing of existing baskets and/or switching to work with a different basket. In one implementation, the basket summary may be presented to the user, which may present summary information regarding a currently active basket. If the user clicks the Define RFQ button 117, Define RFQ user interface element 132 may be presented to the user to facilitate entry of RFQ information.

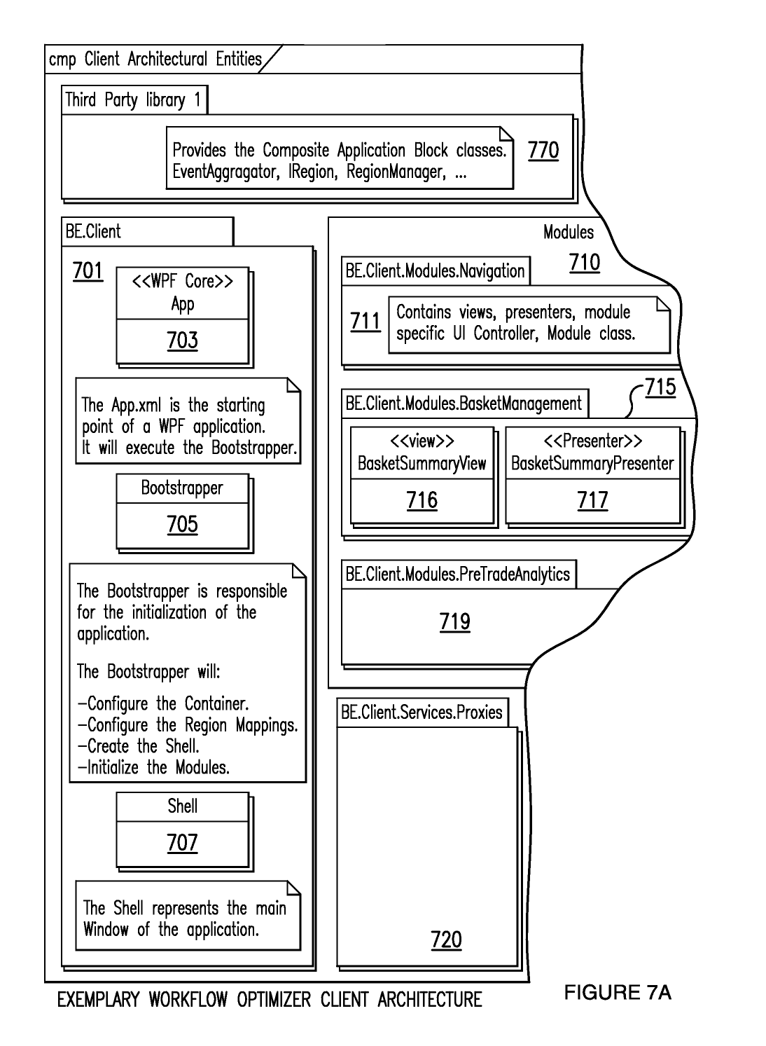

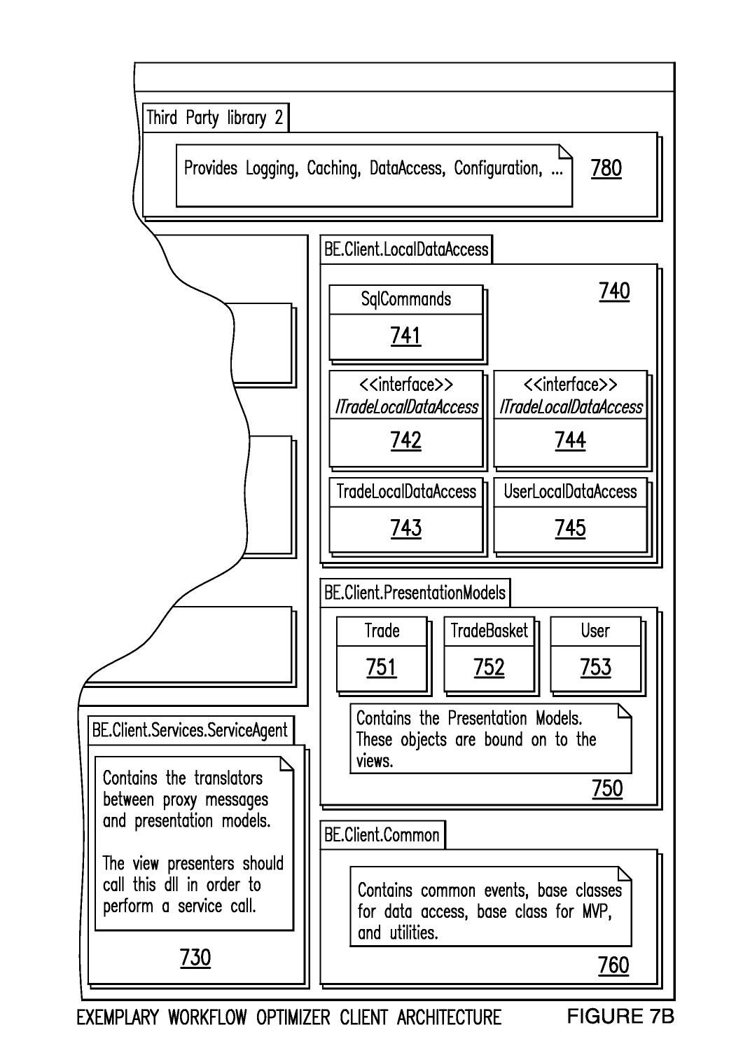

FIG. 2 is of a logic flow diagram illustrating updating of the incremental container user interface based on user progress in one embodiment of the WORKFLOW OPTIMIZER. In one embodiment, the WORKFLOW OPTIMIZER may use a hierarchical state machine to model user workflow and/or sub-flows and update the incremental container user interface using the hierarchical state machine. See FIG. 7 for additional exemplary implementation details of the hierarchical state machine. In FIG. 2, a user logs into the WORKFLOW OPTIMIZER at 201. In one embodiment, processing user log in may be based on the data stored in a database, such as a user database table 2019a. For example, the user's username and password may be compared to data stored in the user database table 2019a to determine whether the user supplied acceptable credentials. In another embodiment, the WORKFLOW OPTIMIZER may not involve user login (e.g., when the WORKFLOW OPTIMIZER is used as a training tool).

The user may select a data container (e.g., a basket of index securities) that the user wants to work with at 205. In one embodiment, the basket may be uploaded by the user from an external program (e.g., from a portfolio optimization program, from a spreadsheet, and/or the like). In one implementation, the basket may be automatically selected upon upload by the WORKFLOW OPTIMIZER. In another implementation, the user may have to select the basket manually. In another embodiment, the basket may already exist in the WORKFLOW OPTIMIZER, and the user may select it (e.g., from a list of baskets). In one embodiment, the basket may be associated with the user and may be stored in a database table (e.g., in the user database table 2019a). In another embodiment, the basket may be stored in a file (e.g., a file containing a comma separated list of identifiers associated with the basket).

The WORKFLOW OPTIMIZER receives an indication of the user's progress with respect to the basket at 210. In one embodiment, this information may be retrieved from a database table (e.g., the user database table 2019a) using one or more SQL statements. In another embodiment, this information may be retrieved from a file that may take on the following form:

SUB-FLOW: Pre-Trade
ACTION: Pre-Trade Analytics | STATUS: Complete
ACTION: Set Basket Strategy | STATUS: Complete
ACTION: Set Transaction Strategy | STATUS: Complete
ACTION: Review Check List | STATUS: Incomplete
ACTION: Sign-Off | STATUS: Incomplete

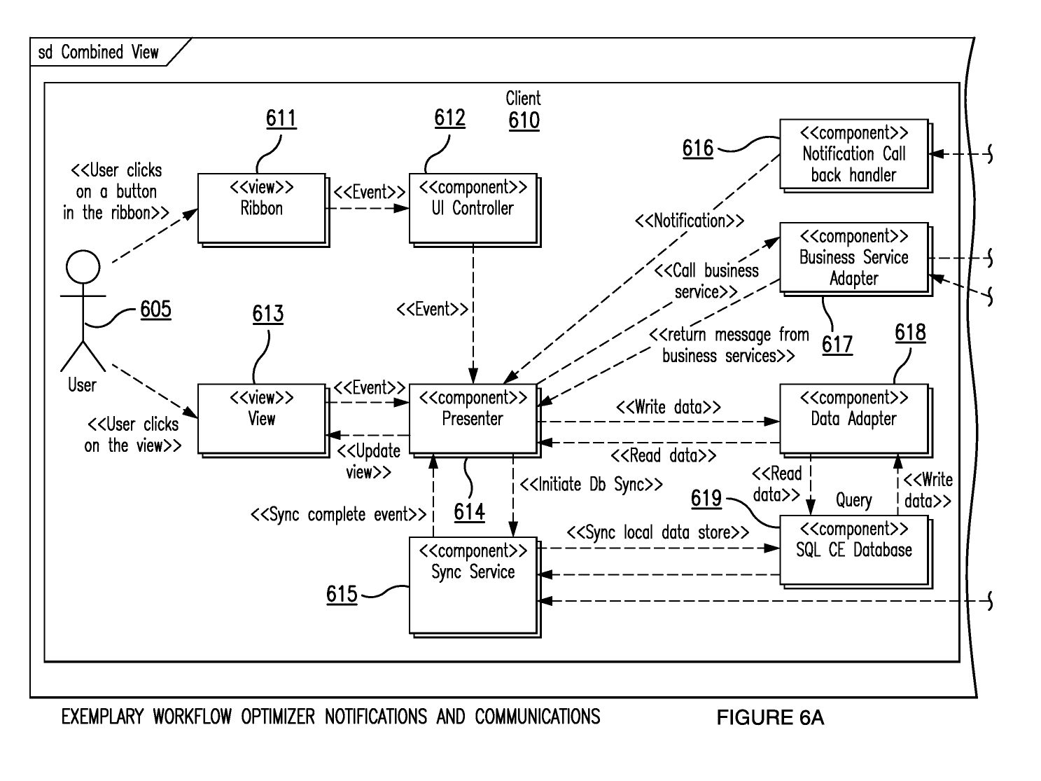

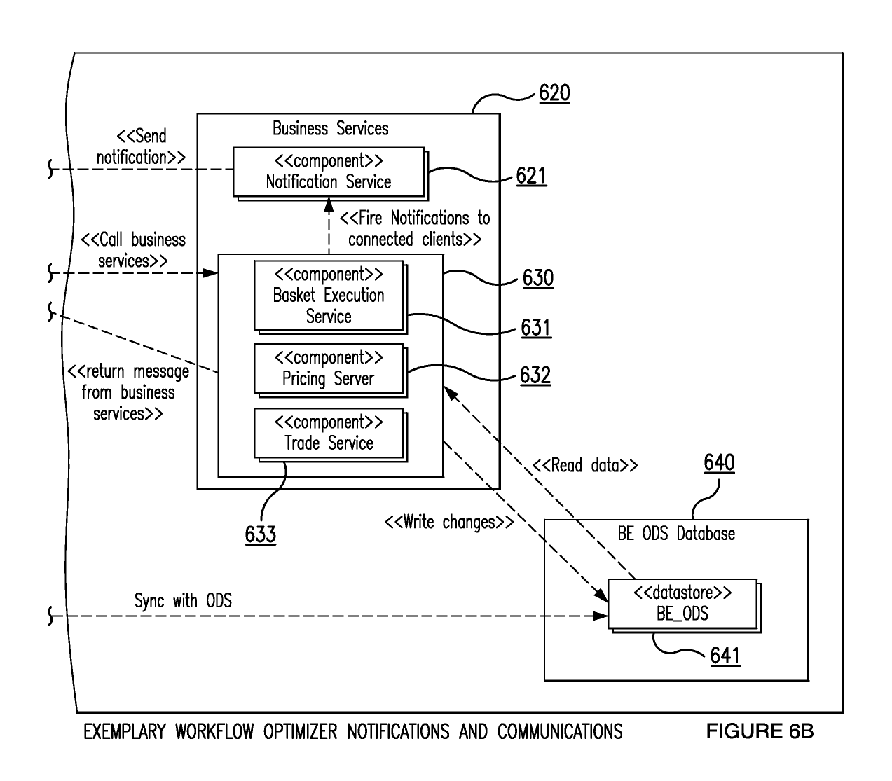

and may be retrieved and parsed using a programming language, such as PL/I, Perl, and/or the like. In one embodiment, a hierarchical state machine may be used to keep track of the user's progress through workflows and/or sub-flows, and user progress data may be retrieved based on the state of the hierarchical state machine (e.g., state stored in the user database table 2019a). For example, the sub-flows and actions associated with the basket may be determined by the hierarchical state machine. See FIGS. 6, 7, and 8 for additional exemplary implementation details of the hierarchical state machine.

The overall workflow (e.g., portfolio management workflow) may comprise a plurality of workflow sub-flows (e.g., Basket Validation, Pre-Trade, RFQ and Broker Selection, Basket Execution, Post-Trade, and/or the like). At 215, the WORKFLOW OPTIMIZER determines the current workflow sub-flow relevant to the selected basket. In one embodiment, this determination may be made based on the user's progress. For example, if the user reviewed the pre-trade check list but did not sign-off, the WORKFLOW OPTIMIZER may determine that the current sub-flow is Pre-Trade (see FIG. 15). In one implementation, data regarding user's progress stored by a hierarchical state machine may be compared to the states of the hierarchical state machine (e.g., stored in a workflow sub-flow database table 2019b) to determine the next action to be completed by the user and the current sub-flow associated with the next action. In one embodiment, the current sub-flow may be one of the sub-flows stored in the workflow sub-flow database table 2019b (e.g., stored as one or more table entries describing the sub-flow). In another embodiment, the current workflow sub-flow may be one of the sub-flows stored in a configuration file (e.g., an XML file). In yet another embodiment, a class structure may exist with a class for each workflow sub-flow and the current sub-flow may be selected from existing classes. In one implementation, the class structure may be based on polymorphism and the code may be written in a programming language such as .NET, Java, C++, and/or the like.

A workflow sub-flow may have sequential actions associated with it. In one embodiment, sequential actions are those actions that are sufficient to complete the workflow sub-flow and that are performed in a particular order to complete the workflow sub-flow. In one implementation, performing only some of the sequential actions may be sufficient to complete a sub-flow. In one implementation, the order in which the sequential actions should be performed may not be a total order (e.g., some of the actions may be performed in any order). For example, in the Pre-Trade sub-flow, the basket strategy may be set for all transactions or the transaction strategy may be set for individual transactions, and, if both are used, either the basket strategy or the transaction strategy may be set first (see FIG. 15).

At 220, the WORKFLOW OPTIMIZER determines the sequential actions associated with the current workflow sub-flow. In one embodiment, the sequential actions may be those stored in a sequential action database table 2019c. In another embodiment, the sequential actions may be those stored in a configuration file (e.g., an XML file) and may take on the following form:

```
<XML>
          <SUB-FLOW>
                <SUB-FLOW NAME>Pre-Trade</SUB-FLOW
                NAME>
                <SEQUENTIAL ACTIONS>
                        <ACTION>Pre-Trade Analytics</ACTION>
                        <ACTION>Set Basket Strategy</ACTION>
                        <ACTION>Set Transaction
                        Strategy</ACTION>
                        <ACTION>Review Check List</ACTION>
                        <ACTION>Sign-Off</ACTION>
                </SEQUENTIAL ACTIONS>
          </SUB-FLOW>
</XML>
```

In yet another embodiment, a class structure may exist with a class for a sequential action and the sequential actions may be selected from existing classes. In one implementation, the class structure may be based on polymorphism and the code may be written in a programming language such as .NET, Java, C++, and/or the like. For example, in one embodiment, sequential actions associated with sub-flows of the portfolio management workflow may be as illustrated in FIG. 15 (actions on the left of a separator in a ribbon—e.g., Map Account, Map Instrument for Basket Validation sub-flow).

A workflow sub-flow may have relevant actions associated with it. In one embodiment, relevant actions are those actions that are applicable to the workflow sub-flow, but which are not necessarily performed in a particular order. In one implementation, a workflow sub-flow may be completed without performing any relevant actions. For example, in the Pre-Trade sub-flow, the user may Sign-Off and proceed to the RFQ and Broker Selection sub-flow without performing any of the relevant actions (see FIG. 15).

At 225, the WORKFLOW OPTIMIZER determines the relevant actions associated with the current workflow sub-flow. In one embodiment, the relevant actions may be those stored in a relevant action database table 2019d. In another embodiment, the relevant actions may be those stored in a configuration file (e.g., an XML file) and may take on the following form:

```
<XML>
          <SUB-FLOW>
                <SUB-FLOW NAME>Pre-Trade</SUB-FLOW
                NAME>
                <RELEVANT ACTIONS>
                        <ACTION>Add Transaction</ACTION>
                        <ACTION>Move Transaction</ACTION>
                        <ACTION>Delete Transaction</ACTION>
                        <ACTION>Delete Basket</ACTION>
                        <ACTION>Append Basket</ACTION>
                </RELEVANT ACTIONS>
          </SUB-FLOW>
</XML>
```

In yet another embodiment, a class structure may exist with a class for a relevant action and the relevant actions may be selected from existing classes. In one implementation, the class structure may be based on polymorphism and the code may be written in a programming language such as .NET, Java, C++, and/or the like. For example, in one embodiment, relevant actions associated with sub-flows of the portfolio management workflow may be as illustrated in FIG. 15 (actions on the right of a separator in a ribbon—Add Transaction, Move Transaction, Delete Transaction, Delete Basket, Append Basket for the Pre-Trade sub-flow).

Based on the above determined data, the WORKFLOW OPTIMIZER may display an updated user interface, including an updated user interface ribbon, and await user input at 230. In one implementation, data regarding user's progress stored by a hierarchical state machine may be compared to the states of the hierarchical state machine (e.g., stored in the workflow sub-flow database table 2019b, the sequential action database table 2019c, the relevant action database table 2019d, and/or the like) to determine (e.g., using a state transition table) next actions (e.g., sequential and/or relevant actions) that may be completed by the user, and the corresponding sub-flow associated with next actions. In one embodiment, an incremental container user interface, such as a ribbon, may correspond to each workflow sub-flow, and the displayed ribbon may correspond to the current workflow sub-flow. In one embodiment, a widget, such as a button, may correspond to each sequential action and to each relevant action, and the displayed buttons may correspond to those sequential actions and relevant actions that are associated with the current workflow sub-flow. In one embodiment, the displayed ribbon may be logically, physically, and/or the like separated into at least two parts including a first part that comprises buttons corresponding to the sequential actions associated with the current workflow sub-flow and a second part that comprises buttons corresponding to the relevant actions associated with the current workflow sub-flow. In one embodiment, the buttons corresponding to the sequential actions may be sequentially ordered in the order in which the sequential actions may be performed to complete the workflow sub-flow. In one embodiment, buttons may be enabled and/or disabled based on the user's progress. In one implementation, buttons may be enabled and/or disabled to guide the user through the workflow and/or sub-flow, to prevent errors, and/or the like. For example, buttons corresponding to sequential actions Select Broker, Send RFQ, Enter Quote and Accept Quote in the RFQ and Broker Selection sub-flow may be disabled until the user completes the Define RFQ sequential action, the button for which is enabled upon completion of the Pre-Trade sub-flow (see FIG. 15). In another example, the button corresponding to the Reject Quote relevant action in the RFQ and Broker Selection sub-flow may be disabled until the user completes the Send RFQ sequential action (see FIG. 15). In one implementation, performing sequential actions may affect which sequential and/or relevant actions may be performed next, and performing relevant actions may affect which sequential and/or relevant actions may be performed next. For example, buttons may be enabled and/or disabled based on performed actions.

At 235, the user may perform an action using the WORKFLOW OPTIMIZER. For example, the user may perform a sequential action, a relevant action, log out, and/or the like. In one embodiment, the WORKFLOW OPTIMIZER may determine the kind of action that the user performed. For example, in the portfolio management workflow, the user may perform trade basket management 240, pre-trade analysis 241, generation of request for quotation (RFQ) 242, trade execution 243, post-trade analysis 244, or the user may perform some other action, such as selecting a different basket to work with, or choose to log out 245. In one embodiment, the WORKFLOW OPTIMIZER may offer hints and/or suggestions to the user based on the performed action. For example, upon selection of a new basket, the WORKFLOW OPTIMIZER may suggest to the user to map an invalid transaction to a valid account or to a valid instrument. In one implementation, this suggestion may take the form of highlighting the relevant transaction (e.g., in yellow color). In another example, the WORKFLOW OPTIMIZER may automatically switch to the next ribbon upon completion of relevant steps in the current ribbon (e.g., upon user Sign-Off in the Pre-Trade sub-flow). In yet another example, the WORKFLOW OPTIMIZER may change an image associated with a button to indicate that the user completed an action (e.g., having a check mark on the Review Check List button of the Pre-Trade sub-flow when the user reviews a checklist). In one implementation, the WORKFLOW OPTIMIZER may confirm that the user completed an action (e.g., for basket validation). In another implementation, the WORKFLOW OPTIMIZER may mark an action as complete without confirming (e.g., that the user reviewed a checklist).

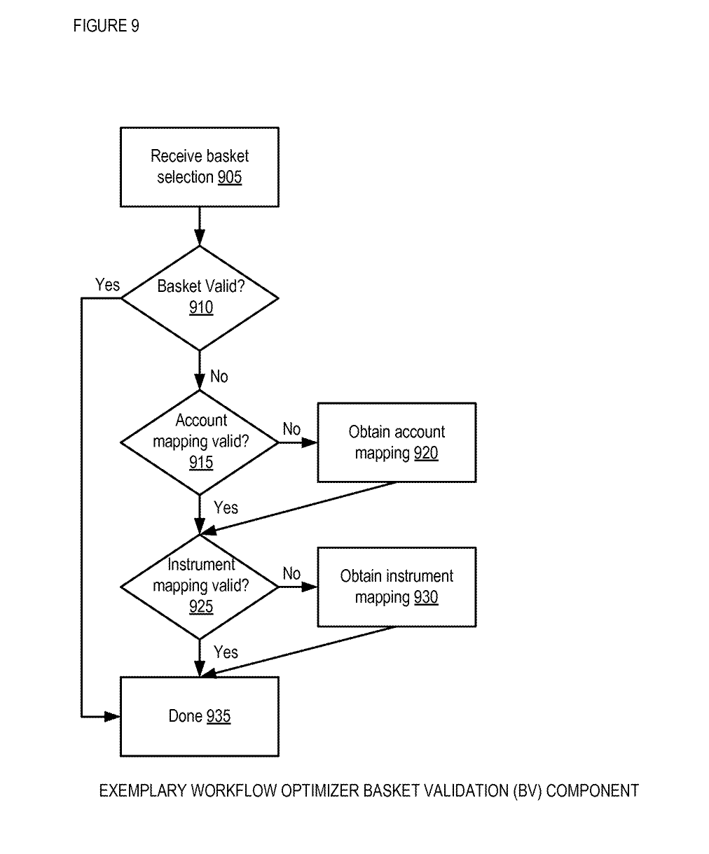

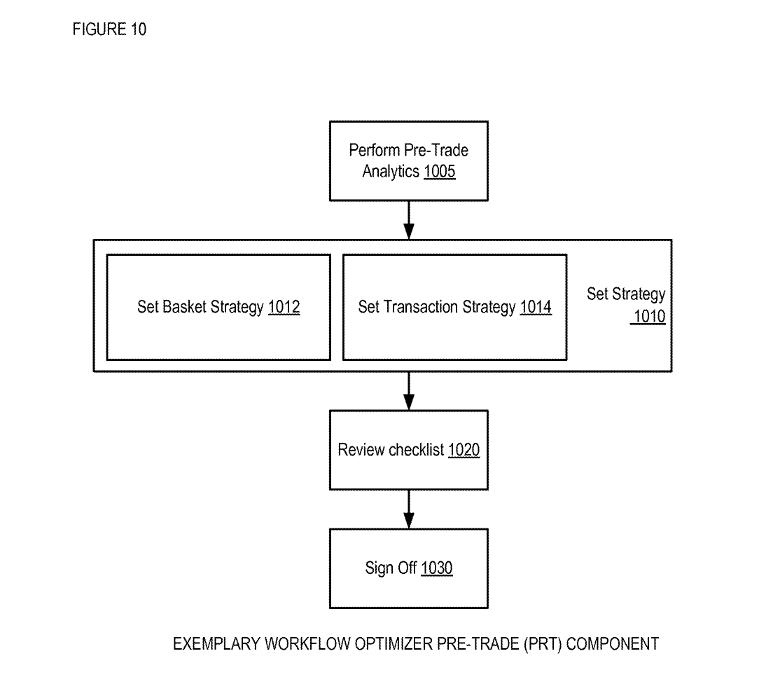

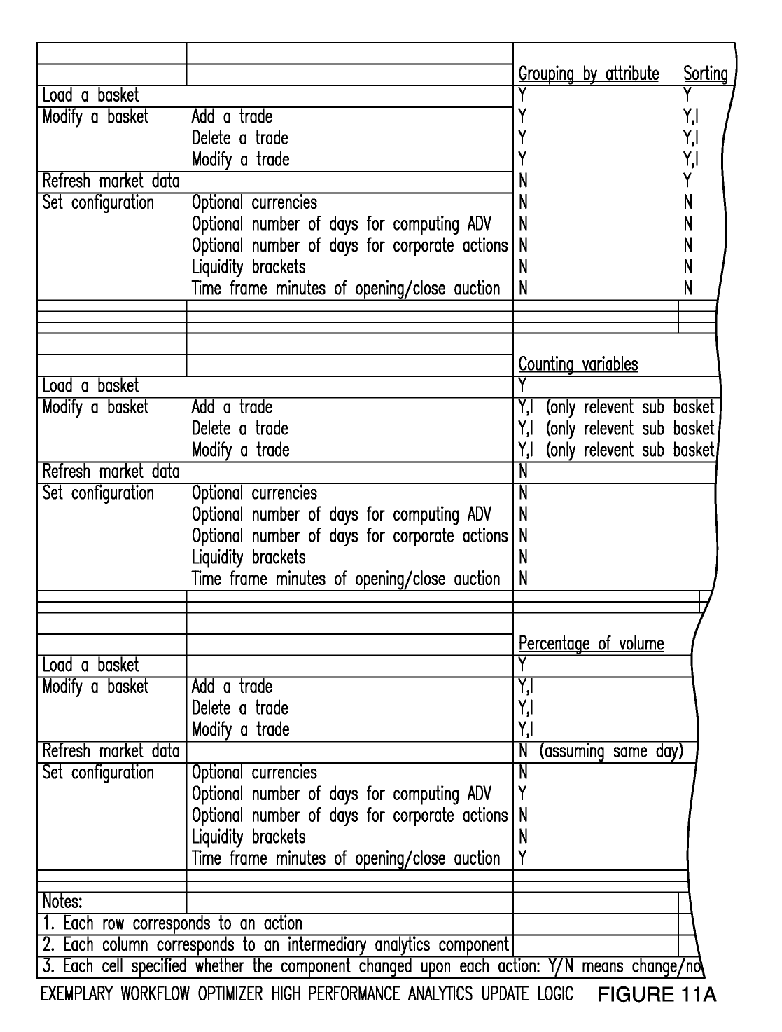

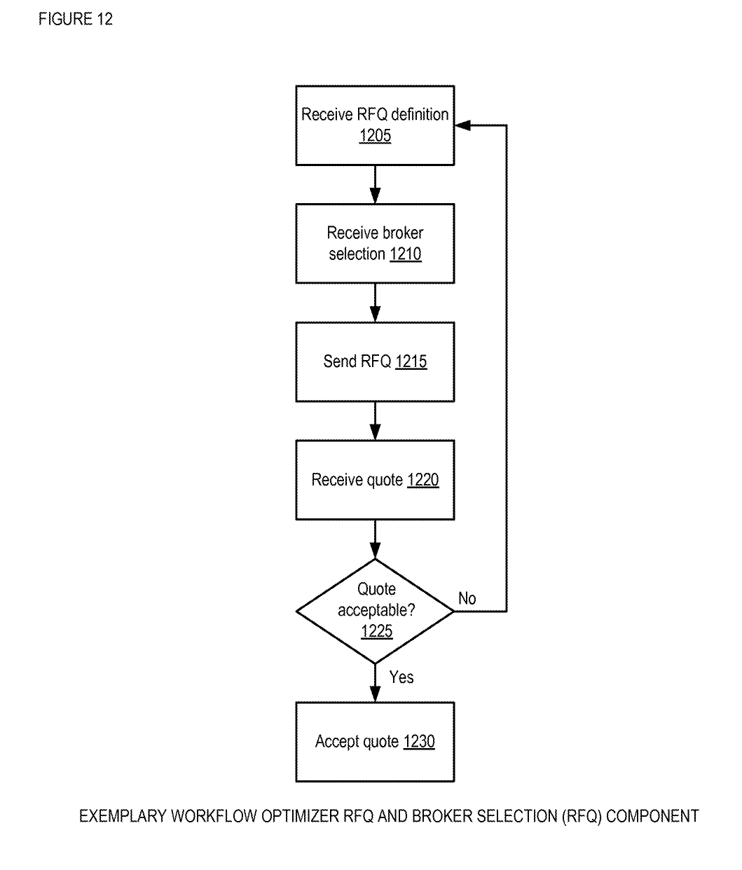

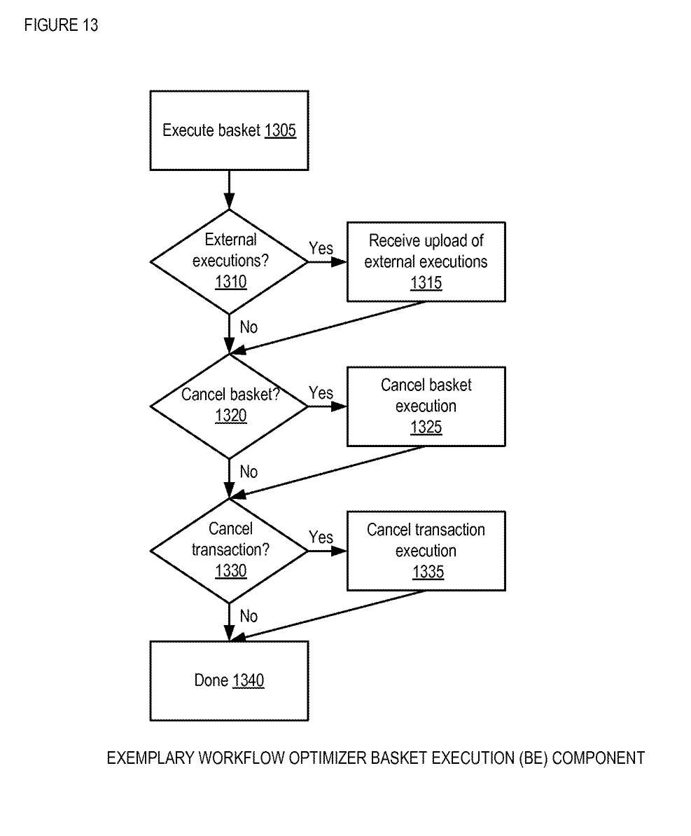

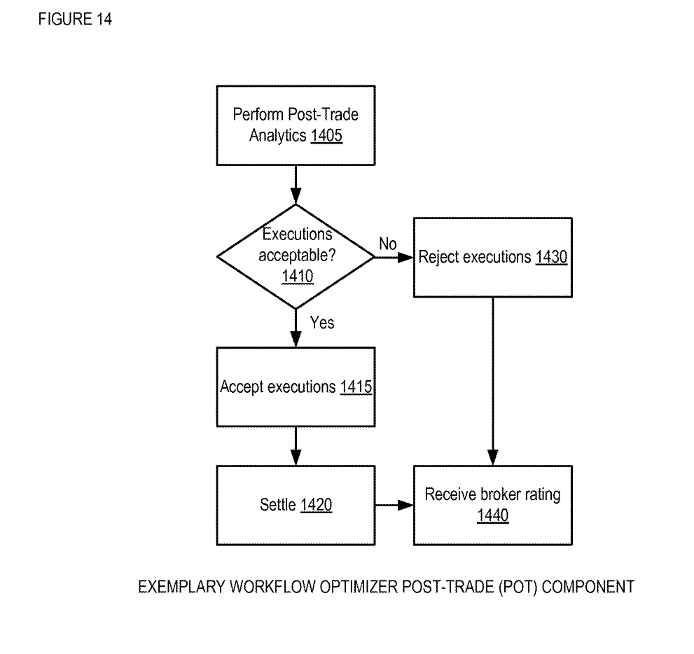

In one embodiment, trade basket management 240 may involve actions such as reviewing trading restrictions, merging/splitting baskets, validating accounts and/or instruments, and/or the like. See FIG. 9 for additional details regarding trade basket management. In one embodiment, pre-trade analysis 241 may involve performing pre-trade analytics (e.g., calculating a basket of assets to track an identified tracking index), setting basket and/or transaction strategy, reviewing a check list, signing off, and/or the like. See FIG. 10 for additional details regarding pre-trade analysis. In one embodiment, request for quotation (RFQ) generation and broker selection 242 may involve defining a RFQ, selecting a broker, sending a RFQ, entering a quote, accepting a quote, and/or the like. See FIG. 12 for additional details regarding RFQ generation and broker selection. In one embodiment, trade execution 243 may involve executing a basket, uploading executions, canceling a basket, canceling a transaction, and/or the like. See FIG. 13 for additional details regarding trade execution. In one embodiment, post-trade analysis 244 may involve performing post-trade analytics, accepting executions, settlement, rating a broker, and/or the like. See FIG. 14 for additional details regarding post-trade analysis.

If the user chooses to log out 245, the WORKFLOW OPTIMIZER may save relevant information (e.g., in the user database table 2019a, the workflow sub-flow database table 2019b, the sequential action database table 2019c, the relevant action database table 2019d, and/or the like) and end program execution 260. Otherwise, the WORKFLOW OPTIMIZER may update the user progress indicator 250 and update the user interface again starting at 210. In one embodiment, the progress indicator may be stored in a database and updated using one or more SQL statements to record which actions have been completed. In another embodiment, the progress indicator may be stored in a file and updated using commands in a programming language, such as PL/I, Perl, and/or the like.

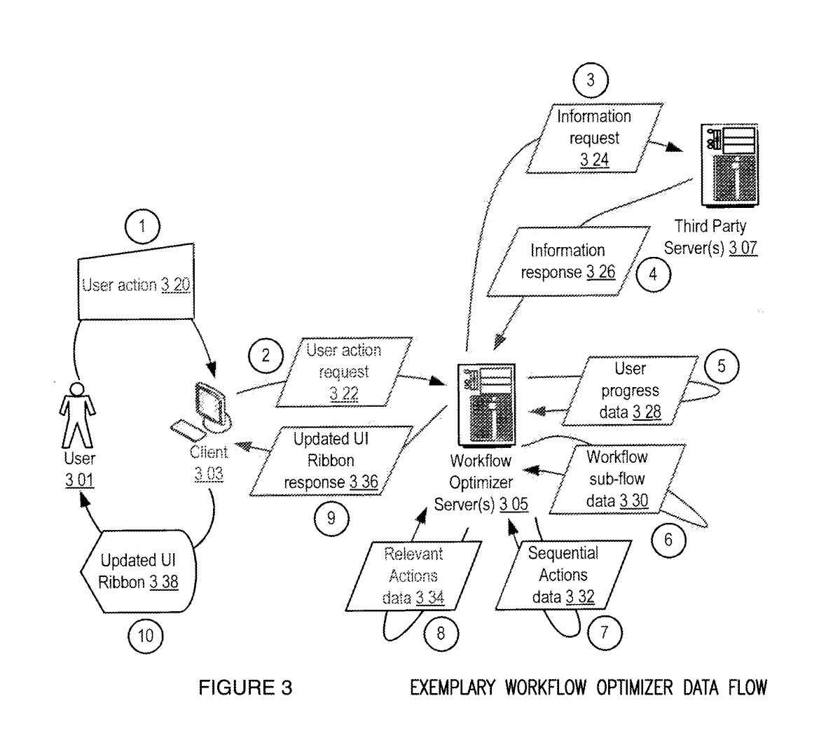

FIG. 3 illustrates data flow in one embodiment of the WORKFLOW OPTIMIZER. In FIG. 3, a user 301 may send a user action 320 to a client 303. In one embodiment, the user action may be an action associated with the current sub-flow associated with a selected data container (e.g., a basket). For example, the user action may be a request to execute a basket. In one implementation, the user may use a keyboard, a mouse, and/or the like to input the user action 320 (e.g., using a user interface of the WORKFLOW OPTIMIZER).

In one embodiment, the client 303 may send a user action request 322 to a workflow optimizer server 305 to facilitate the execution of the user action (e.g., executing a basket). In one implementation, the user action request 322 may involve a call (e.g., using a dynamic link library (DLL)) from the client to the server (e.g., data may be passed using a database). In another implementation, the user action request may be in XML format and may take on the following form:

```
<XML>
          <Action>Execute Basket</Action>
          <BasketID>ID123</BasketID>
          <BrokerID>ID456</BrokerID>
</XML>
```

In one embodiment, the workflow optimizer server 305 may send an information request 324 to a third party server 307. For example, the workflow optimizer server 305 may send a request to a broker to execute an order. In one implementation, the information request may be sent using Financial Information eXchange (FIX) protocol and the information request may take on the following form:

8=FIX.4.2|9=120|35=E|49=INSTITUTION|56=BROKER|52=20101103-
14:28:30|34=200|66=14|394=1|68=1|73=1|11=Order1|67=1|55=
SPY|54=2|38=1000|40=1|10=005

The above message indicates that it is in FIX 4.2 format, it is sent from an institution to a broker, and it is for a market order to sell 1000 shares of SPY.

The third party server 307 may respond to the workflow optimizer server 305 with an information response 326. For example, the information response may be a confirmation and/or details of order execution. In one implementation, the information response may be sent using FIX protocol and may take on the following form:

8=FIX.4.2|9=146|35=8|49=BROKER|56=INSTITUTION|52=20101103-
14:30:30|34=200|66=14|37=Order1|17=ExecID1|55=SPY|54=2|38=
1000|40=1|20=3|150=2|39=2|151=0|14=1000|6=120|10=110

The above message indicates that it is in FIX 4.2 format, it is sent from a broker to an institution, and it indicates that the order was filled at an average price of 120.

In one embodiment, the workflow optimizer server 305 may analyze user progress data 328 (e.g., retrieved from the user database table 2019a), workflow sub-flow data 330 (e.g., retrieved from the workflow sub-flow database table 2019b), sequential actions data 332 (e.g., retrieved from the sequential action database table 2019c), relevant actions data 334 (e.g., retrieved from the relevant action database table 2019d), and/or the like, to determine how to update the incremental container user interface. For example, this data may be analyzed, as described with regard to FIG. 2, to determine which ribbon to display to the user and which buttons on the ribbon should be enabled and/or disabled.

In one embodiment, the workflow optimizer server 305 may send an updated user interface ribbon response 336 to the client 303. In one implementation, the response may include information (e.g., programming instructions) that facilitates updating the incremental container user interface on the client. In another implementation, the response may include information updated as a result of the user action (e.g., an XML file with information regarding the executed basket order). In one embodiment, the client 303 may output the result of the user action 338 to the user 301. In one implementation, the client 303 may output the result using a monitor, speakers, a printer, and/or the like. For example, the client 303 may update the ribbon to indicate that the user executed a basket.

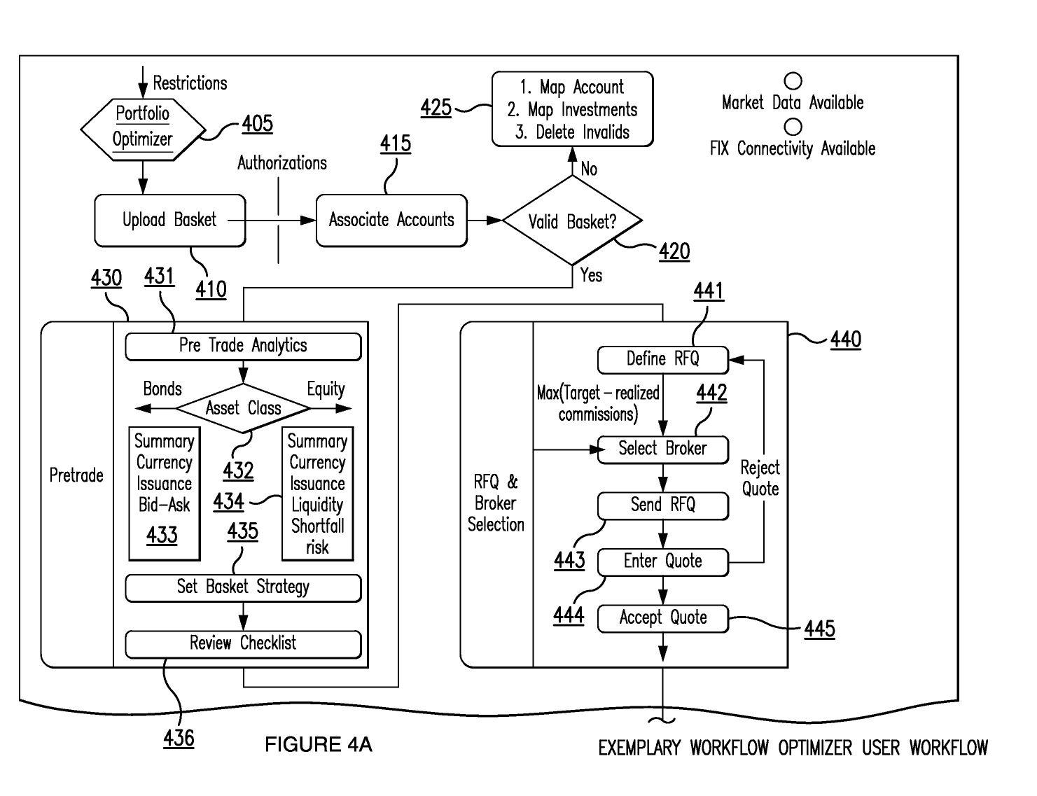

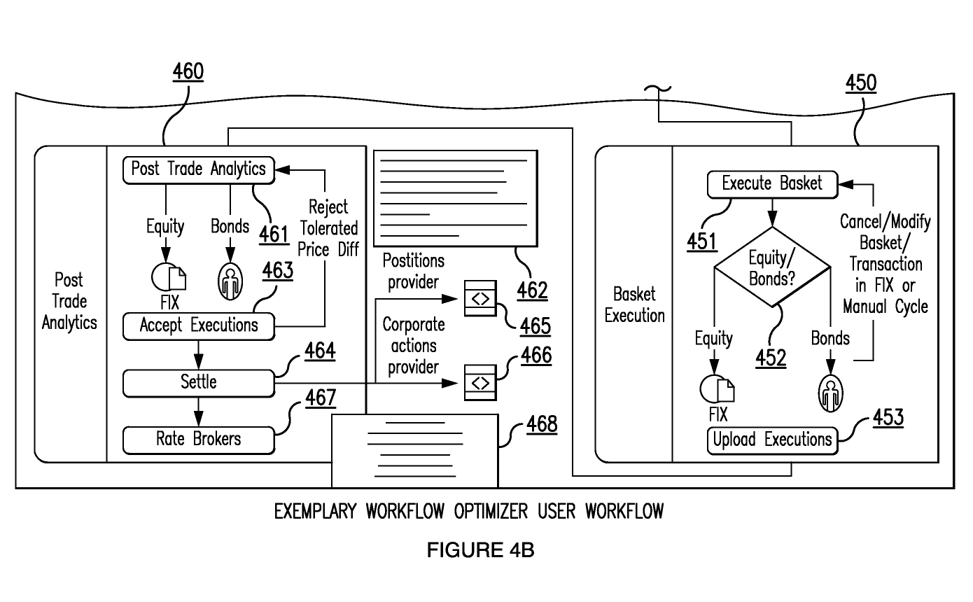

FIGS. 4A and 4B show a block diagram illustrating user workflow in one embodiment of the WORKFLOW OPTIMIZER. In this embodiment, the portfolio management workflow is described. In one implementation, an incremental container user interface (e.g., a ribbon) may correspond to each workflow sub-flow as described further in, for example, FIGS. 9, 10, 12, 13, 14, and shown, for example, in FIG. 15.

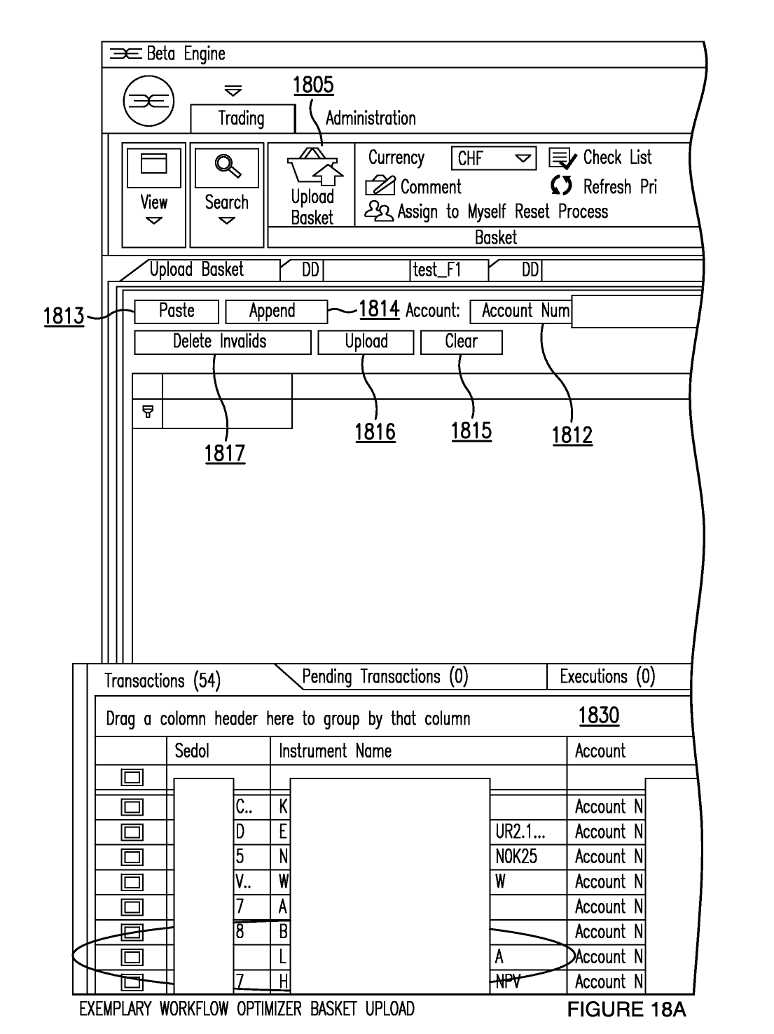

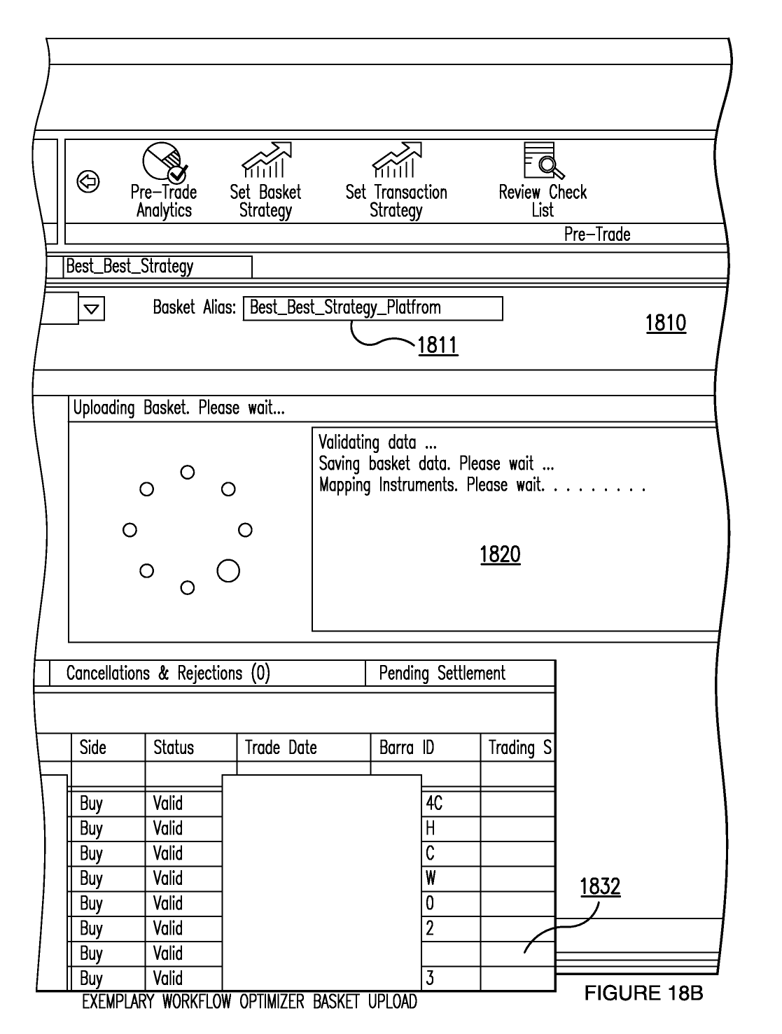

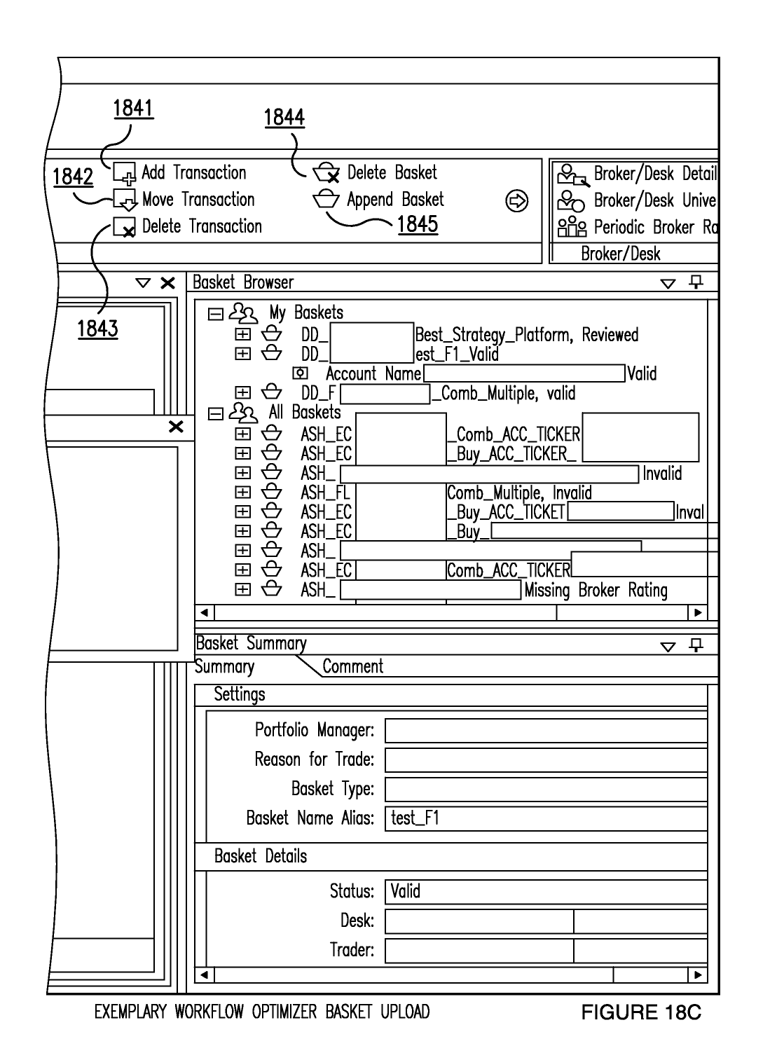

In one embodiment, the portfolio manager may input a list of non-restricted instruments into a portfolio optimizer at 405. Using the optimizer the portfolio manager may determine a desired combination of instruments (e.g., based on risk compared to expected reward), and upload the desired combination of instruments as a basket of instruments at 410. See FIG. 18 for addition details regarding uploading a basket.

Basket Validation—The WORKFLOW OPTIMIZER may associate the basket with a user account at 415. At 420, a determination may be made whether the basket is valid. If the basket is not valid, the basket may have to be associated with a valid account, and instruments may have to be mapped so that they are recognized by the WORKFLOW OPTIMIZER or deleted at 425.

Pre-Trade 430—The portfolio manager may perform pre-trade analytics on the basket at 431. For example, the pre-trade analytics performed may depend on the type of the asset class 432 (e.g., different type of analysis for bonds and equities). For example, bonds may be analyzed with regard to summary, currency, issuance, bid-ask, and/or the like 433. In another example, equity may be analyzed with regard to summary, currency, issuance, liquidity, shortfall risk, and/or the like 434. The portfolio manager may also set a basket strategy at 435 (e.g., collectively for the whole basket or individually for specific instruments). The portfolio manager may also review a checklist at 436 to confirm that various tasks have been completed (e.g., tasks set by a system administrator).

RFQ and Broker Selection 440—The portfolio manager may define a RFQ at 441, select a broker at 442, send the RFQ to the broker at 443 (e.g., via email), and/or enter the quote at 444. The portfolio manager may continue doing this until an acceptable quote is received and the portfolio manager accepts the quote at 445.

Basket Execution 450—The portfolio manager may execute the basket at 451 and cancel and/or modify the basket or the transaction. For example, the basket may be executed in a variety of way depending on the asset class 452 (e.g., equities may be executed using FIX, while bonds may be executed via a phone call and/or email). The portfolio manager may upload executions transacted externally (e.g., over the phone) at 453.

Post-Trade 460—The portfolio manager may perform post-trade analytics on the basket at 461. In one embodiment, post trade analytics may be performed with regard to execution price vs. selected strategy benchmark price, execution completeness, recalculating taxes and commissions to recheck broker sent values, market impact, settlement data checked against pre-trade, and/or the like 462. For example, the portfolio manager may reject executions in which the execution price exceeds the tolerated price difference associated with a selected strategy. The portfolio manager may accept executions at 463. The transactions may be settled at 464 and data regarding executions may be provided to a positions provider 465, a corporate actions provider 366, and/or the like. The brokers may be rated at 467. For example, the brokers may be rated with regard to quality of execution, quality of settlement, trade support, market coverage, and/or the like 468.

In one embodiment, data regarding actions performed by the user, basket data, quote data, and/or the like historical data regarding the portfolio management workflow of a basket may be stored. In one implementation, this data may be used to replay a recorded portfolio management workflow. For example, a recorded workflow may be replayed to audit a portfolio manager, to train users, and/or the like. In another implementation, this data may be used to replay and modify a recorded workflow. For example, a portfolio manager may wish to purchase instruments purchased in a recorded workflow by another portfolio manager, and may ease this task by replaying the recorded workflow and adjusting purchase prices. In one implementation, historical data regarding the portfolio management workflow of a basket may be stored in an XML file and may take on the following form:

```
<XML>
    <WorkFlowID>ID_12</WorkFlowID>
    <ActionHistory>
      <Action>
          <ActionID>1</ActionID>
          <ActionType>Select Basket</ActionType>
          ...
      </Action>
      <Action>
          <ActionID>2</ActionID>
          <ActionType>Click Pre-Trade Analytics button</ActionType>
          ...
      </Action>
      ...
    </ActionHistory>
    <Basket>
      <BasketName>My Basket</BasketName>
      <BasketID>BID_34</BasketID>
      <BasketItems>
          <Item>SPY</Item>
          <Item>IWM</Item>
          <Item>...</Item>
      </BasketItems>
    ...
    </Basket>
    <Quote>
      <QuoteID>QID_56</QuoteID>
      <Broker>Broker 1</Broker>
      <QuoteDate>11/1/2010</QuoteDate>
      <QuoteTime>11:30:00am</QuoteTime>
      <EnteredBy>Portfolio Manager X</EnteredBy>
      <QuoteItems>
          <QuoteItem>
            <Item>SPY</Item>
            <QuotedPrice>119.35</QuotedPrice>
            <Comment>A comment</Comment>
            ...
          </QuoteItem>
      </QuoteItems>
    ...
    </Quote>
    ...
</XML>
```

In one embodiment, historical data regarding a recorded workflow may be provided to the hierarchical state machine to facilitate replaying and/or modifying a recorded workflow.

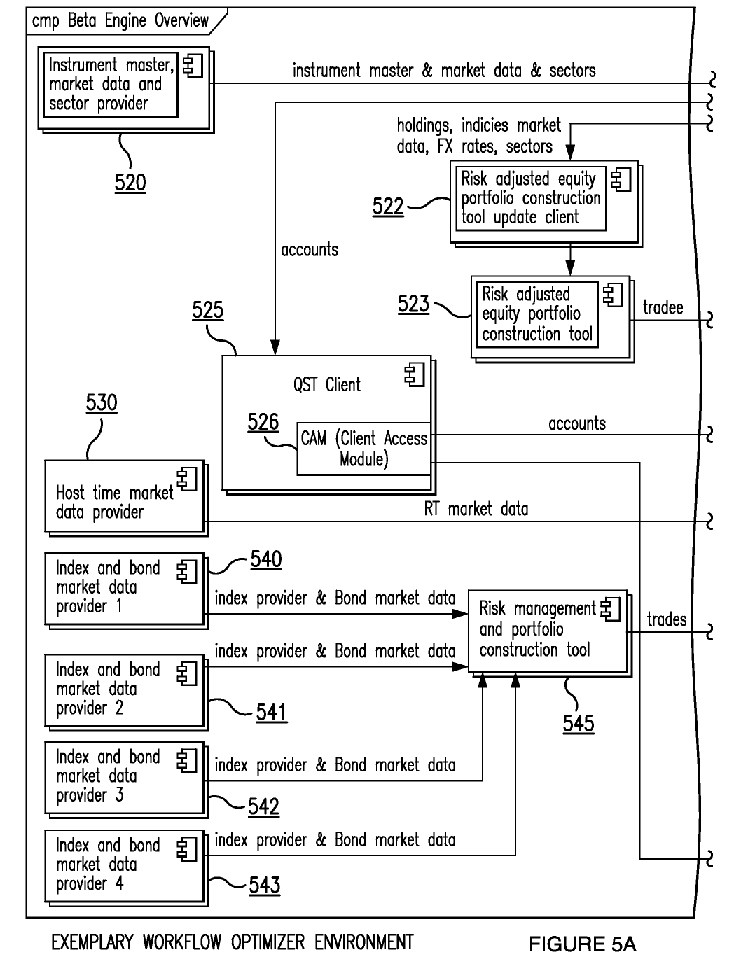

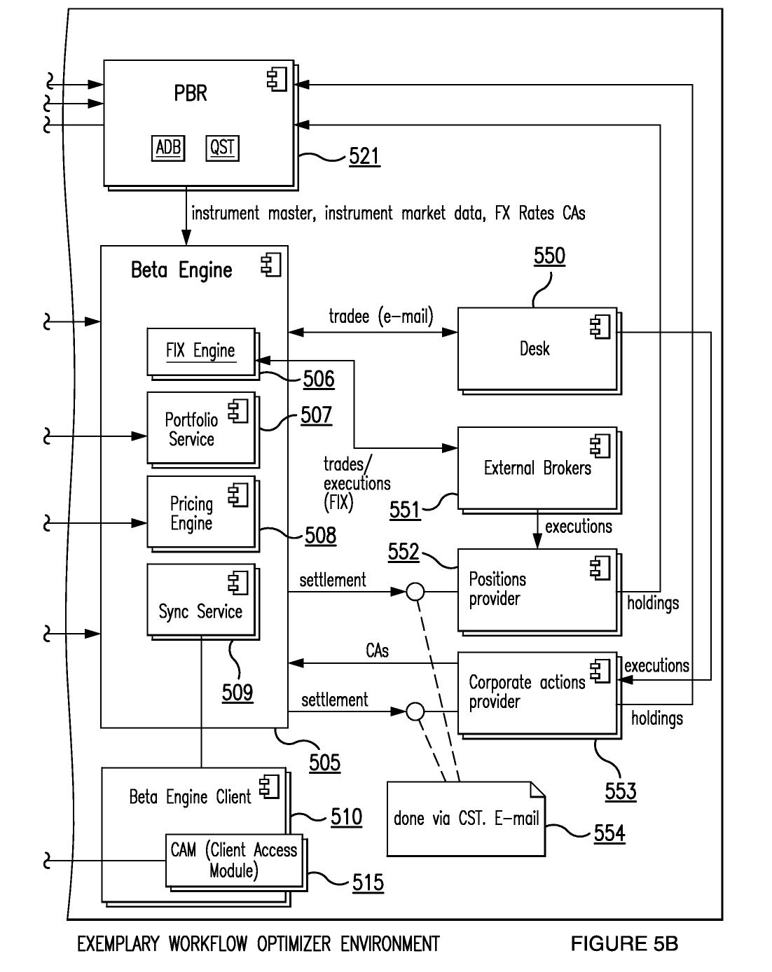

FIGS. 5A and 5B show a block diagram illustrating workflow optimizer environment in one embodiment of the WORKFLOW OPTIMIZER. In FIGS. 5A and 5B, the WORKFLOW OPTIMIZER, also referred to as Beta Engine and/or BE may comprise a server 505 and a client 510. The workflow optimizer server may include various engines and/or services. For example, the workflow optimizer server may include a FIX Engine 506, a Portfolio Service 507, a Pricing Engine 508, a Sync Service 509, and/or the like.

The workflow optimizer server 505 may receive market data, sector data, historical data, and/or the like from various data providers (e.g., FactSet, Bloomberg, IBoxx, Barra, SWX, Barclays, and/or the like). In one implementation, the workflow optimizer server 505 may receive real time market data from the real time market data provider 530. For example, such data may be stored by the WORKFLOW OPTIMIZER (e.g., in a market data database table 2019e), and may be used by the WORKFLOW OPTIMIZER in various workflow sub-flows (e.g., Pre-Trade Analytics, Post-Trade Analytics, and/or the like).

In one implementation, the workflow optimizer server 505 may receive trades from risk management and portfolio construction tool 545 (e.g., a portfolio optimizer) based on data received from index and bond market data providers 540, 541, 542, and/or 543. In one implementation, the workflow optimizer server 505 may receive trades from risk management and portfolio construction tool 523 based on data received by tool 523 from risk adjusted equity portfolio construction tool update client 522. Risk adjusted equity portfolio construction tool 522 may receive holdings, indices market data, foreign exchange rates, sectors data, and/or the like from PBR 521.

PBR 521 may also provide instrument master, instrument market data, foreign exchange rates, corporate actions (CAs), and/or the like to the workflow optimizer server 505, and data regarding client accounts to QST Client 525. In one implementation, PBR 521 may receive instrument master, market data, sectors data, and/or the like from instrument master, market data, and sector provider 520. In one implementation, PBR 521 may receive data regarding holdings from positions provider 552 and/or from corporate actions provider 553.

The workflow optimizer server 505 may communicate with desk 550 and/or external brokers 551 (e.g., via email, using FIX protocol, and/or the like) regarding trades and/or executions of trades. The workflow optimizer server 505 may send settlement data (e.g., via email, capturing and settlement tool (CST), and/or the like 554) to positions provider 552 and/or to corporate actions provider 553, and may receive corporate actions data from corporate actions provider 553. In one embodiment, desk 550 and/or external brokers 551 may send executions data to positions provider 552 and/or to corporate actions provider 553.

In one implementation, a portfolio manager may use a workflow optimizer client 510 to access the WORKFLOW OPTIMIZER features provided by a workflow optimizer server 505. In one implementation, the workflow optimizer client may access client data (e.g., data associated with human and/or institutional clients of the portfolio manager's firm) using a client access module (CAM) 515. For example, the CAM may allow a portfolio manager to manage a client's portfolio without revealing confidential client data (e.g., names, account numbers, and/or the like) to the portfolio manager. In one implementation, CAM 526 may facilitate access to anonymized client data by communicating with CAN 515, with portfolio service 507, and/or the like.

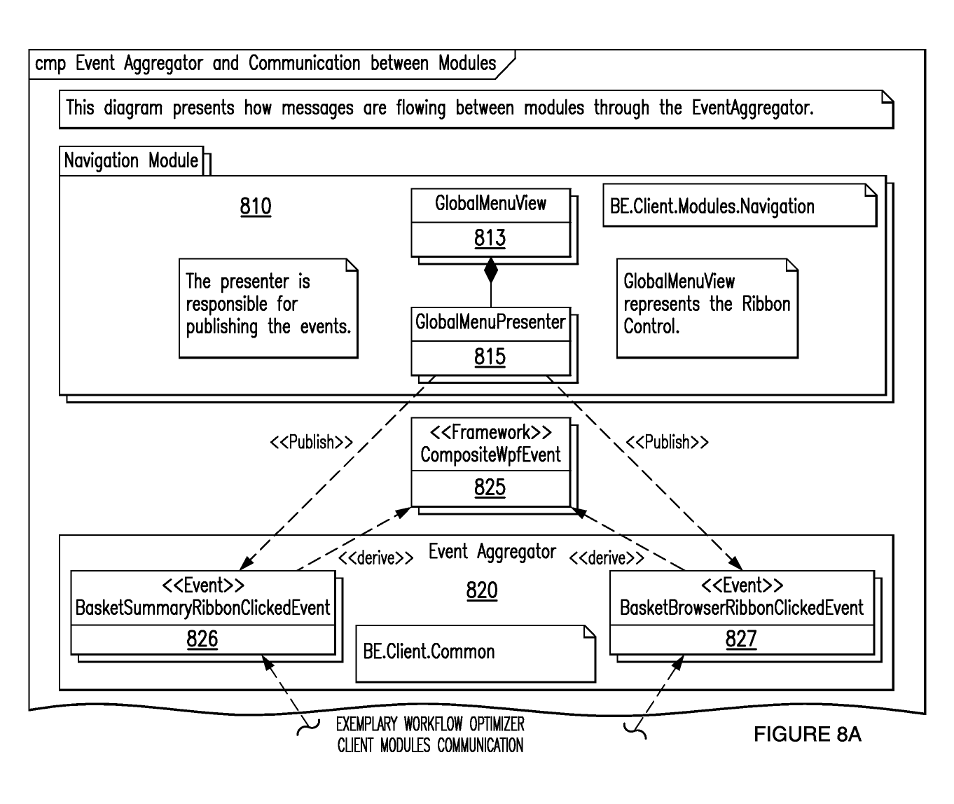

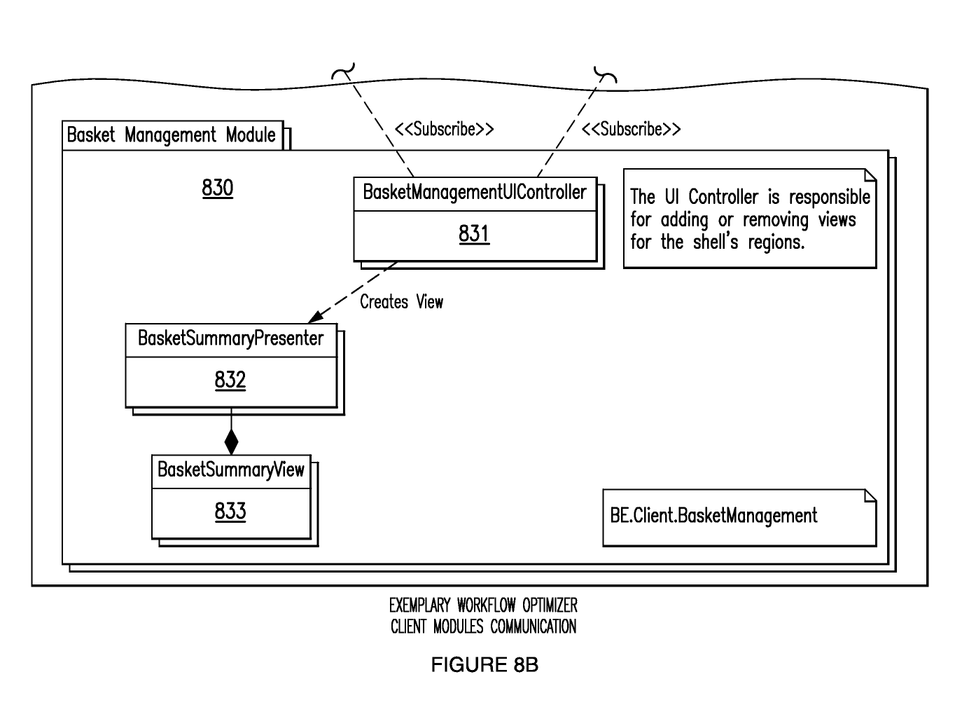

FIGS. 6A and 6B show a block diagram illustrating workflow optimizer notifications and communications in one embodiment of the WORKFLOW OPTIMIZER, also referred to as Beta Engine and/or BE. In FIGS. 6A and 6B, a user 605 using a workflow optimizer client 610 may interact with a workflow optimizer client's views (e.g., views 611 and/or 613). In one embodiment, views may represent ribbons 611 (see, e.g., FIG. 15), other controls associated with a sub-flow 613 (e.g., a user interface that facilitates broker selection in the RFQ and Broker Selection sub-flow—see FIG. 1), and/or the like. In one implementation, the views are polymorphic classes written in a programming language such as .NET, Java, C++, and/or the like. In one implementation, a view may send events (e.g., user clicks on a button, moves a mouse, and/or the like) to a user interface controller 612 and/or to a presenter 614. In one implementation, a user interface controller 612 may be responsible for adding and/or removing views in the main window of the workflow optimizer client application, for updating a view, and/or the like. In one implementation, a presenter 614 may be responsible for publishing events to a user interface controller, for updating a view, for data communication between components, for calling services, and/or the like. In various implementations, a user interface controller and a presenter may be combined into one class, responsibilities may be redistributed between a user interface controller and a presenter, multiple classes may be used to represent a user interface controller and/or a presenter, and/or the like. See FIG. 8 for additional details regarding interaction between user interface controllers and presenters.

In one embodiment, the workflow optimizer client 610 may read and/or write data to a local datastore (e.g., a database, a file, and/or the like). In one implementation, the workflow optimizer client 610 may use the presenter 614 to read and/or write data to a local datastore 619 via a data adapter 618 (e.g., the presenter may issue commands in a programming language such as .NET, Java, C++, and/or the like, and the data adapter may issue SQL queries corresponding to those commands). In one embodiment, the workflow optimizer client 610 may synchronize the local datastore 619 with a remote database 640 using a synchronization service 615 to access data from a remote datastore 641 located in the remote database 640.

In one embodiments, the workflow optimizer client 610 may call remote services 630 (e.g., remote services 630 may comprise basket execution service 631, pricing server 632, trade service 633, and/or the like). In one implementation, the workflow optimizer client 610 may use the presenter 614 to send and/receive messages from remote services 630 via a business service adapter 617 (e.g., the business service adapter may facilitate communication between distributed components). In one implementation, remote services 630 may read and/or write data to the datastore 641 located in the remote database 640. In one embodiment, the workflow optimizer client may use services via notification callbacks. In one implementation, the workflow optimizer client 610 may use the presenter 614 to receive notifications via a notification call back handler 616, from remote services 630 that send notifications via a notification service 621. In one embodiment, business services 620 may comprise remote services 630 and notification service 621.

FIGS. 7A and 7B show a block diagram illustrating workflow optimizer client architecture in one embodiment of the WORKFLOW OPTIMIZER, also referred to as Beta Engine and/or BE. In FIGS. 7A and 7B, a Windows Presentation Foundation (WPF) application 701 may execute a bootstrapper 705. In one embodiment, the bootstrapper 705 may be responsible for initialization of the application. In one implementation, the bootstrapper may create a shell 707. The shell 707 may represent the main window of the workflow optimizer client application.

In one embodiment, the shell may contain one or more modules 710. In one implementation, the shell may contain a navigation module 711 that contains an incremental container user interface (e.g., a ribbon). For example, the navigation module may contain views, presenters, user interface controllers, and/or the like associated with the incremental container user interface (e.g., code for managing buttons, separators, and/or the like of the ribbon). In one implementation, the shell may contain a module associated with a workflow sub-flow (e.g., the RFQ and Broker Selection sub-flow—see FIG. 1) and/or an action of a sub-flow (e.g., Define RFQ—see FIG. 1). In one implementation the shell may contain a basket management module 715, a pre-trade analytics module 719, and/or the like. For example, the module may contain views (e.g., basket summary view 716), presenters (e.g., basket summary presenter 717), user interface controllers, and/or the like associated with the sub-flow and/or the action of the sub-flow (e.g., code for managing a user interface that facilitates RFQ definition in the RFQ and Broker Selection sub-flow). In one implementation, the navigation module may contain a reference, a pointer, and/or the like to the module (e.g., to an instance of the module class) associated with the current workflow sub-flow. For example, the incremental container user interface may display and/or enable and/or disable different user interface elements depending on the type (e.g., class type) of the module instance (e.g., different buttons may be displayed for ribbons associated with different sub-flows).

In one implementation, presentation models 750 (e.g., presentation models 750 may comprise trade model 751, trade basket model 752, user model 753, and/or the like) may be associated with views of a module. For example, a presentation model may specify user interface elements associated with a view and/or business logic associated with user interface elements.

In one implementation, a module may access local (e.g., client) and/or remote (e.g., server) data. In one implementation, local data may be accessed using local data access library 740 that includes SQL commands 741, local data access classes (e.g. trade local data access class 743 that implements an interface 742, user local data access class 745 that implements an interface 744, and/or the like), and/or the like. In one implementation, remote data may be accessed using services via services proxies library 720, services agent library 730, and/or the like. In one implementation, data access classes, services, and/or the like may use a common library 760 (e.g., containing common events, base classes for data access, utilities, and/or the like). In one implementation, a library may be a dynamic link library (DLL). In one implementation, third party libraries (e.g., 770, 780, and/or the like) may be used by the application.

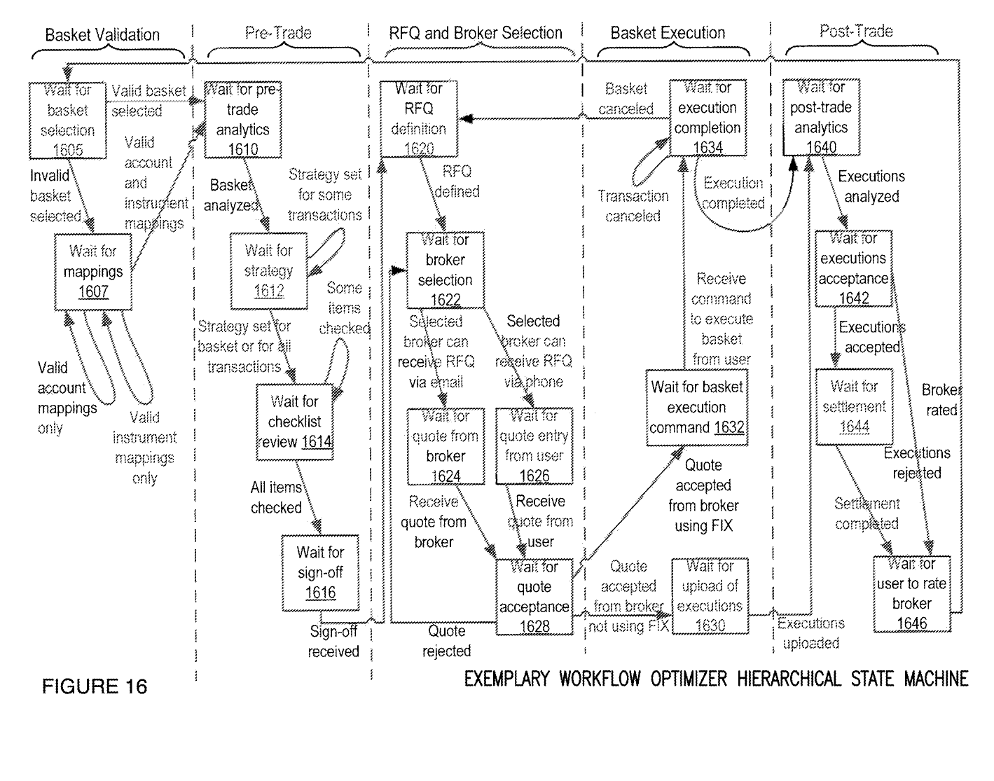

In one embodiment, a module may use a hierarchical state machine to model user workflow and/or sub-flows and/or actions and update the incremental container user interface using the hierarchical state machine. For example, the hierarchical state machine may model a workflow on a first hierarchy level (e.g., which ribbons are part of the workflow and how to transition between ribbons), and a sub-flow on a second hierarchy level (e.g., which actions are part of a sub-flow and how to transition between actions). See FIG. 16 for an exemplary embodiment of a hierarchical state machine. In one implementation, the hierarchical state machine may interact with one or more user interface controllers, presenters, and/or the like associated with the module. In one implementation, the hierarchical state machine may be implemented using one or more state transition tables. For example, a state transition table may be stored in a database, in a configuration file, hardcoded, and/or the like, and may take on the following form:

| CURRENT STATE: | A | B | C |
|---|---|---|---|
| INPUT: | NEXT STATE: | | |
| 1 | A | B | C |
| 2 | B | C | A |
| 3 | A | B | A |

The state transition table illustrated above describes how the next state of a state machine may be determined based on the current state and the input (e.g., if the current state is A, and the input is 2, the next state is B). For example, a state transition table may specify that the Sign-Off button in the Pre-Trade sub-flow may be enabled (e.g., next state) if the current ribbon is Pre-Trade (e.g., current state) and Review Check List action is completed (e.g., input). In one implementation, the hierarchical state machine may be implemented as a service and/or a service framework.

FIGS. 8A and 8B show a block diagram illustrating client modules communication in one embodiment of the WORKFLOW OPTIMIZER, also referred to as Beta Engine and/or BE. FIGS. 8A and 8B illustrate communication between modules of the workflow optimizer client application. In one embodiment, modules may communicate using messages sent via Publish/Subscribe messaging technique. For example, a module associated with a workflow sub-flow and/or an action of a sub-flow (e.g., Basket Management module 830) may subscribe to messages published by a navigation module 810 (e.g., a ribbon associated with that sub-flow) to facilitate user interaction with the application (e.g., update the status of a basket in Basket Summary upon user action, such as Send RFQ—see FIG. 1). In another example, a navigation module may subscribe to messages published by a module associated with a workflow sub-flow and/or an action of a sub-flow to facilitate user interaction with the application (e.g., if the user selects a different basket in a Basket Browser, the ribbon may be updated to represent user progress in the selected basket—see FIG. 1).

In one implementation, a module (e.g., a navigation module 810) may publish events (e.g., using a global menu presenter 815, a user interface controller, and/or the like) associated with the global menu view 813 (e.g., a ribbon). In one implementation, events sent by a view (e.g., global menu view 813) and/or by a user interface controller may be received by the global menu presenter 815 and published using an event aggregator 820. In one implementation, the event aggregator 820 maintains a list of publishers and a list of subscribers, maintains associations indicating publishers from which a subscriber is interested in receiving events, receives events from subscribers, and notifies publishers regarding the events in accordance with the associations. In one implementation, the event aggregator 820 may contain events (e.g., basket summary ribbon clicked event 826, basket browser ribbon clicked event 827, and/or the like) that derive from a common base class (e.g., composite WPF event 825).

In one implementation, a module (e.g., a Basket Management module 830) may subscribe to events (e.g., using a presenter, a user interface controller, and/or the like). For example, the Basket Management module 830 may indicate that it wants to receive particular events (e.g., mouse click events) from the navigation module. In one implementation, events sent by the event aggregator 820 may be received by the basket management user interface controller 831, and sent to a basket summary presenter 832 and/or to a basket summary view 833. For example, if the user uses the Basket Validation ribbon to delete an invalid transaction, an event may be sent to the Basket Management module and the basket status in the basket summary view may be changed from invalid to valid.

FIG. 9 is of a logic flow diagram illustrating a basket validation component in one embodiment of the WORKFLOW OPTIMIZER. In one embodiment, the basket validation component may correspond to the Basket Validation sub-flow of the portfolio management workflow. In FIG. 9, basket selection may be received at 905. For example, the user may select a basket from the Basket Browser (see FIG. 1). In one embodiment, the WORKFLOW OPTIMIZER may determine whether the selected basket is valid at 910. In one implementation, predetermined rules (e.g., specified by a system administrator, hard coded, and/or the like) may be checked to determine whether the basket is valid. For example, validation rules may specify that a basket should be mapped to a valid account and each instrument in a basket should be mapped to a valid identifier. If the determination at 910 indicates that the basket is not valid, the user may be prompted to fix rule violations (e.g., by displaying the Basket Validation ribbon). In one implementation, if it is determined that an account mapping is not valid 915, a valid account mapping may be obtained from the user at 920 (e.g., through the user interface of the workflow optimizer client). In one implementation, if it is determined that an instrument mapping is not valid 925, a valid instrument may be obtained from the user at 930. In one implementation, if the basket is valid, the Basket Validation sub-flow may be complete 935 and the user may move on to the next sub-flow. For example, if the determination at 910 indicates that the basket is valid, the user may be presented with the ribbon associated with the next workflow without seeing the Basket Validation ribbon. In another example, the user may be automatically presented with the ribbon associated with the next workflow upon correcting rule violations. In yet another example, the WORKFLOW OPTIMIZER may let the user switch to the next ribbon manually.

FIG. 10 is of a logic flow diagram illustrating a pre-trade component in one embodiment of the WORKFLOW OPTIMIZER. In one embodiment, the pre-trade component may correspond to the Pre-Trade sub-flow of the portfolio management workflow. In FIG. 10, pre-trade analytics may be performed at 1005. For example, the user may want to analyze the basket and/or instruments in the basket with regard to turnover, liquidity, country breakdown, market breakdown, and/or the like (e.g., using data in a database). In one implementation, pre-trade analytics may involve calculating a basket of assets to track an identified tracking index.

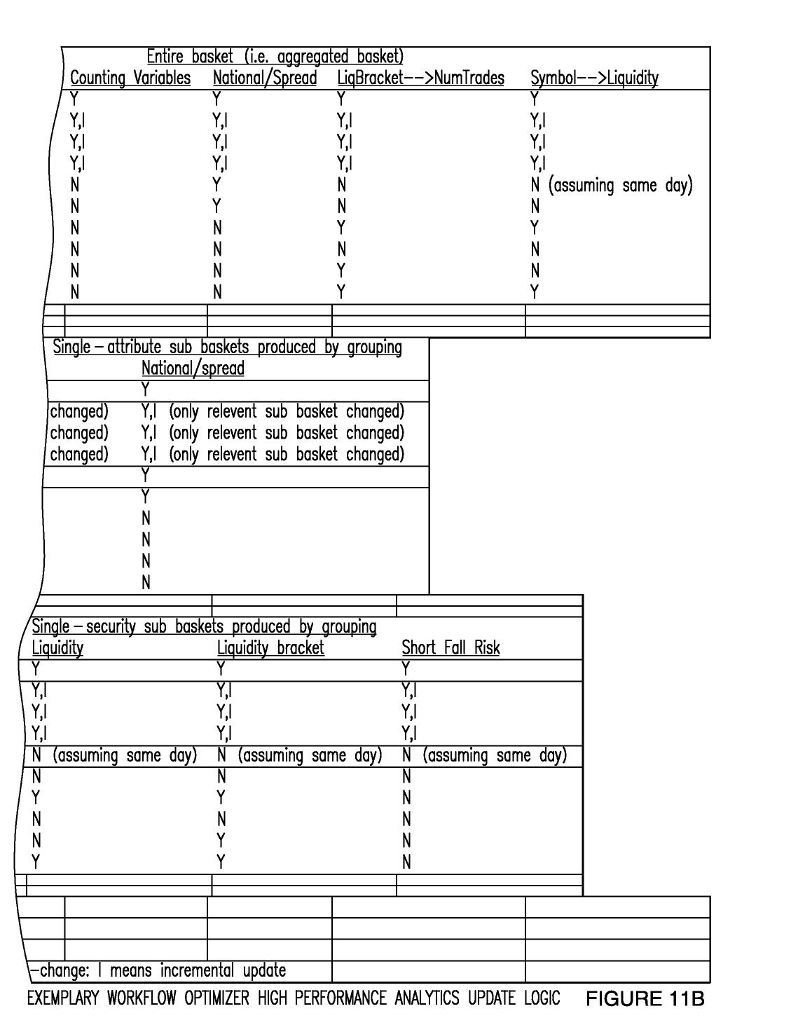

In one embodiment, calculations are accelerated through a “high performance computing” facility. In one embodiment, the high performance computing facility may take on the form described below. Performance optimizations may include: decomposition of analytics—upon each action, only part of the analytics may be updated, and the part that stays unchanged may be re-used instead of re-computed; and incremental update—when analytics are to be updated, one may do incremental update, rather than compute from scratch. In one implementation the pre-trade analytics may be decomposed into multiple intermediary analytics components and the high performance analytics update logic may be implemented as shown in FIGS. 11A and 11B, which summarizes for a given action which analytics components have changed, which analytics components have not changed, and which analytics components may be updated incrementally. In one implementation, the order of updating the intermediary analytics components may impact calculations (e.g., correctness of calculations, calculations performance, and/or the like).

Returning back to FIG. 10, in one embodiment, the set of analytics may be decomposed into the following components: Grouping—grouping of trades by certain attributes, including security, country and currency. In one implementation, the entire basket is a trade basket, and the trades corresponding to a single attribute, for example, the trades corresponding to a single currency, also constitute a (sub) trade basket. Sorting—lists of securities, countries, currencies and clients sorted by USD notional, and securities sorted by liquidity. Counting variables—some analytics metrics of a basket are counting (or additive) variables, including number of names, shares and trades. Real-time variables—notional and spread. A sub trade basket corresponding to a single security, may have the following analytics variables: Percentage of average daily volume (ADV)—there may be three types of volumes (Closing Auction, Opening Auction and Daily Trading Volumes) and two optional numbers of days to compute average. In one implementation, the three types of volumes may be distinguished by different names and each type of volume may be represented as a list containing three double numbers, which correspond to the default number of days, and the other two optional numbers of days. Liquidity—in one implementation, there may be three types of liquidity: Liquidity bracket—which bracket this single-security basket falls in. Short fall risk—in one implementation the shares may be adjusted with the threshold level and P(X<x) may be calculated based on the assumption of normal distribution. For example, this value may be derived based on 120 days historical trading volume. Other analytics variables include mapping from liquidity bracket to number of trades and mapping from security symbol to liquidity of the corresponding single-security sub-basket.

In one embodiment, upon adding/deleting/modifying a trade, the following variables may be incrementally updated: Sorting—adding/deleting an element into/from a sorted list may be done in an incremental fashion. In one implementation this may be done using a binary search. Counting variables—number of names/shares/trades may be incrementally updated. For example, if the current number of shares of a basket is X_old and a new trade of Y shares is added, then the new number of shares may be X_new←X_old+Y. Real-time variables—in one implementation notional and spread may be incrementally updated. Updating notional may be done in a way similar to updating counting variables. In one implementation updating spread may be done as follows: Suppose the old spread of a basket is given by S_old=N/D=(S_1*N_1+S_2*N_2+S_3*N_3+ . . . )/(N_1+N_2+N_3+ . . . ), where N and D are the numerator and the denominator. Incremental update to S_old may be performed by maintaining N (numerator) and D (denominator). If a new trade is added, where the spread and notional are S′ and N′, the new basket-level spread may be given by S_new←(N+S′*N′)/(D+N′). Liquidity—in one implementation updating liquidity may be done as follows: Suppose the current liquidity for a security is given by L_old=T/V, where T is the total trade size of the security and V is its trading volume. If a new trade of trade size t is added, the new liquidity may be computed as L_new←L_old+t/V.

In one embodiment, strategy may be set at 1010. For example, a strategy may be market on open agency, market on close agency, VWAP, and/or the like. In one implementation, basket strategy may be set for the basket (e.g., based on user selection) at 1012. In another implementation, transaction strategy may be set for individual transactions at 1014. For example, the user may set a strategy for a basket, and override that strategy for selected instruments with a different strategy. In one embodiment, the user may complete checklist review at 1020 (e.g., the checklist may be defined by a system administrator). For example, a checklist may involve checking for unknown assets, checking roundlots, inputting tracking error of result portfolio, checking tracking error history of results portfolio, checking volumes and/or weights, checking flows, checking short positions, checking restricted list, checking investment universe, checking tax tables, and/or the like. In one embodiment, the user may sign-off at 1030 and proceed to the next sub-flow.

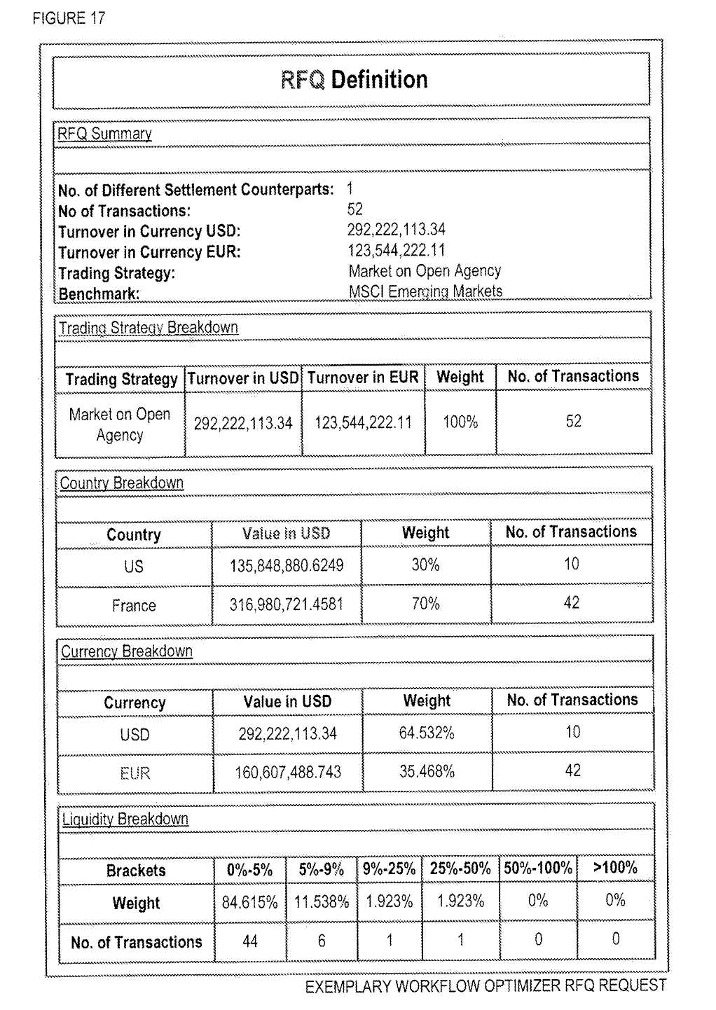

FIG. 12 is of a logic flow diagram illustrating a RFQ and broker selection component in one embodiment of the WORKFLOW OPTIMIZER. In one embodiment, the RFQ and broker selection component may correspond to the RFQ and Broker Selection sub-flow of the portfolio management workflow. In FIG. 12, an RFQ definition may be received from a user at 1205. In one embodiment, the RFQ definition may describe the basket to the broker (see FIG. 17 for an exemplary RFQ definition). In one implementation, the instruments that make up the basket are not included in the RFQ, and the basket is instead defined by its characteristics. For example, such characteristics may include number of settlement counterparts, number of transactions, turnover (e.g., in one or more currencies), trading strategy (e.g., for the basket or broken down by instruments), benchmark, trading strategy breakdown, country breakdown, currency breakdown, liquidity breakdown, and/or the like. In another implementation, the instruments that make up the basket may be used.

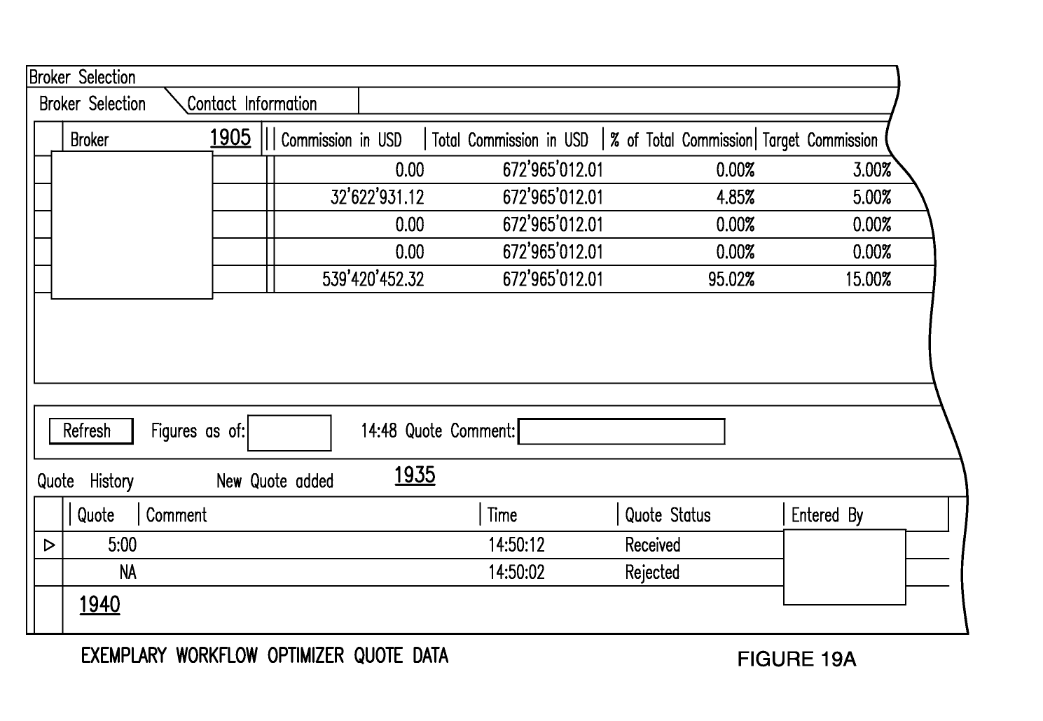

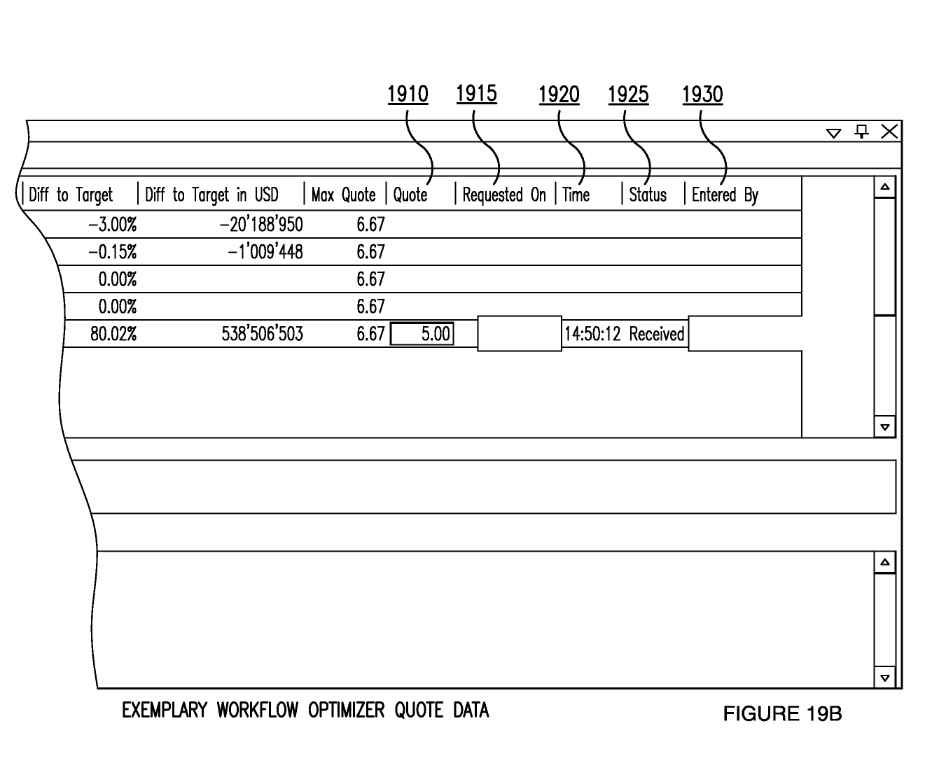

In one embodiment, broker selection may be received from the user at 1210. For example, the user may select a broker based on performance, broker strength in particular areas, target spend with the broker, and/or the like. In one embodiment, an RFQ may be sent to the selected broker at 1215. In one implementation, the RFQ may be sent via email (e.g., with details of the RFQ attached as a PDF document). In one embodiment, a quote may be received from the broker at 1220. In one implementation, the quote may be received via email. For example, the user may provide the WORKFLOW OPTIMIZER with the quote via the application user interface. In another implementation, the quote may be received via a secure website that facilitates quote entry by the broker (e.g., the link to the secure website may be provided to the broker in the RFQ email). See FIG. 19 for additional details regarding maintaining quote data.

A determination may be made at 1225 (e.g., by the user) whether the quote is acceptable. In one embodiment, if the quote is not acceptable, the RFQ definition and Broker Selection sub-flow may be repeated. For example, the user may redefine basket parameters, select a different broker, and/or the like. If the quote is acceptable, the quote may be accepted at 1230, and the user may proceed to the next sub-flow.

FIG. 13 is of a logic flow diagram illustrating a basket execution component in one embodiment of the WORKFLOW OPTIMIZER. In one embodiment, the basket execution component may correspond to the Basket Execution sub-flow of the portfolio management workflow. In one embodiment, a basket may be executed at 1305. In one implementation, a basket may be executed by sending a request to the broker to execute the basket. For example, the request may be sent using FIX protocol as described with regard to FIG. 3. In one implementation, the broker may respond with a confirmation that the basket and/or some of the transactions have been executed, and/or with a fail message indicating that one or more of the transactions have not been executed. For example, the confirmation may be sent using FIX protocol as described with regard to FIG. 3. In one embodiment, an execution request may be sent to the broker via email, phone call, and/or the like. In one implementation, if such external executions occur 1310, the WORKFLOW OPTIMIZER may receive an upload of such external executions from the user at 1315. For example, the user may upload a spreadsheet that contains information describing such external executions (e.g., price, quantity, and/or the like). In one embodiment, if the user wishes to cancel a basket sent for execution 1320, the WORKFLOW OPTIMIZER may cancel basket execution at 1325. For example, the WORKFLOW OPTIMIZER may send a FIX message to the broker requesting cancelation of basket execution. In one embodiment, if the user wishes to cancel a transaction sent for execution 1330, the WORKFLOW OPTIMIZER may cancel transaction execution at 1335. For example, the WORKFLOW OPTIMIZER may send a FIX message to the broker requesting cancelation of transaction execution. In one implementation, upon completion of basket execution, the Basket Execution sub-flow may be complete 1340 and the user may move on to the next sub-flow.

FIG. 14 is of a logic flow diagram illustrating a post-trade component in one embodiment of the WORKFLOW OPTIMIZER. In one embodiment, the post-trade component may correspond to the Post-Trade sub-flow of the portfolio management workflow. In FIG. 14, post-trade analytics may be performed at 1405. For example, the user may want to analyze execution results for the basket and/or for the instruments in the basket with regard to execution price, turnover, country breakdown, currency breakdown, and/or the like. In one implementation, execution price for an instrument in the basket may be compared with a benchmark specified by the set trading strategy to determine whether the execution quality is acceptable. For example, if the set trading strategy is VWAP, the execution price of an instrument may be compared to VWAP for the instrument to determine whether the difference between the execution price and VWAP exceeds a tolerated price difference (e.g., specified by a user). In one embodiment, a determination is made at 1410 whether executions are acceptable (e.g., based on the VWAP). If the executions are acceptable (e.g., the difference between an execution price and VWAP does not exceed a predetermined threshold), the executions may be accepted at 1415, and settled at 1420. If the executions are not acceptable (e.g., the difference between an execution price and VWAP exceeds a tolerated price difference), the executions may be rejected (e.g., by the user) at 1430. In one embodiment, the broker may be rated at 1440. In one implementation, the broker may be rated by the user. For example, the user may rate the broker based on trade support, quote rate, quality of execution, quality of settlement and/or the like (e.g., using a rating from 1 to 5, Good-Average-Bad, and/or the like). In another implementation, the broker may be rated by the WORKFLOW OPTIMIZER based on realized commission as compared to target commission, execution performance, trading volume, and/or the like.

FIG. 15 is of a screen shot diagram illustrating user interface ribbons in one embodiment of the WORKFLOW OPTIMIZER. Ribbons associated with Basket Validation sub-flow, Pre-Trade sub-flow, RFQ and Broker Selection sub-flow, Basket Execution sub-flow, and Post-Trade sub-flow of the portfolio management workflow are illustrated. Two versions of a ribbon are shown for each sub-flow, illustrating in various implementations how user interface elements (e.g., buttons) may be enabled and/or disabled depending on user progress associated with a basket.

FIG. 16 is of a block diagram illustrating a hierarchical state machine in one embodiment of the WORKFLOW OPTIMIZER. The state machine of FIG. 16 illustrates state transitions based on inputs associated with the ribbons of the portfolio management workflow (see FIG. 15) in an exemplary embodiment. In one embodiment, the hierarchical state machine may begin in state 1605 by waiting for a basket selection from a user and by displaying the Basket Validation ribbon with all buttons disabled. If the user selects a valid basket, the hierarchical state machine may transition to state 1610 by waiting for the user to perform pre-trade analytics and by displaying the Pre-Trade ribbon. If the user selects an invalid basket, the hierarchical state machine may transition to state 1607 by waiting for the user to provide valid account and/or instrument mappings and by enabling Map Account and Map Instrument buttons. If the user supplies valid account or instrument mappings, but not both, the hierarchical state machine remains in state 1607. If the user supplies both valid account and valid instrument mappings, the hierarchical state machine may transition to state 1610 by waiting for the user to perform pre-trade analytics and by displaying the Pre-Trade ribbon.

If the user performs pre-trade analytics and analyzes the basket, the hierarchical state machine may transition to state 1612 by waiting to receive trading strategy from the user. If the user sets strategy for some of the transactions, the hierarchical state machine may remain in state 1612. If the user sets strategy for the basket or for all individual transactions, the hierarchical state machine may transition to state 1614 by waiting for checklist review from the user. If the user checks some of the items on the checklist, the hierarchical state machine may remain in state 1614. If the user checks all items on the checklist, the hierarchical state machine may transition to state 1616 by waiting for user sign-off and by enabling the Sign-Off button. If the user signs-off, the hierarchical state machine may transition to state 1620 by waiting for the user to define a RFQ and by displaying the RFQ and Broker Selection ribbon.

If the user defines a RFQ, the hierarchical state machine may transition to state 1622 by waiting for a broker selection from the user and by enabling the Select Broker button. If the user selects a broker that receives a RFQ via email, the hierarchical state machine may transition to state 1624 by waiting for a quote from the broker and by enabling the Send RFQ button. If the user selects a broker that receives a RFQ via a phone, the hierarchical state machine may transition to state 1626 by waiting for a user to enter the quote and by enabling the Enter Quote button. If a quote is received from a broker (if the hierarchical state machine is in state 1624) or if the user enters a quote (if the hierarchical state machine is in state 1626) the hierarchical state machine may transition to state 1628 by waiting for the user to accept or reject the quote. If the user rejects the quote, the hierarchical state machine may transition to state 1622 by waiting for the user to select another broker. If the user accepts the quote, the hierarchical state machine may transition to state 1630 (if the broker is not using FIX) or to state 1632 (if the broker is using FIX) and by displaying the Basket Execution ribbon.

If the hierarchical state machine is in state 1630 and the user uploads executions, the hierarchical state machine may transition to state 1640 by waiting for the user to perform post-trade analytics and by displaying the Post-Trade ribbon. If the hierarchical state machine is in state 1632 and the user sends a command to execute the basket, the hierarchical state machine may transition to state 1634 by waiting for execution completion. If the user cancels some of the transactions, the hierarchical state machine may remain in state 1634. If the user cancels the basket or all transactions, the hierarchical state machine may transition to state 1620 by waiting for the user to define a RFQ and by displaying the RFQ and Broker Selection ribbon. If the execution completes, the hierarchical state machine may transition to state 1640 by by waiting for the user to perform post-trade analytics and by displaying the Post-Trade ribbon.

If the user analyzes executions, the hierarchical state machine may transition to state 1642 by waiting for executions acceptance and by enabling the Accept Executions button. If the user rejects the executions, the hierarchical state machine may transition to state 1646 by waiting for the user to rate the broker. If the user accepts executions, the hierarchical state machine may transition to state 1644 by waiting for settlement and by enabling the Settle button. If the user completes settlement, the hierarchical state may transition to state 1646 by waiting for the user to rate the broker. If the user rates the broker, the hierarchical state machine may transition to state 1605 by waiting for a basket selection from a user and by displaying the Basket Validation ribbon with all buttons disabled.

FIGS. 18A, 18B, and 18C show a screen shot diagram illustrating uploading a basket in one embodiment of the WORKFLOW OPTIMIZER. In FIGS. 18A-C, the user may click Upload Basket button 1805 to indicate that the user wishes to upload a basket. In one embodiment, Upload Basket user interface 1810 may be presented to the user to facilitate basket upload. In one implementation, the user may name the basket using the Basket Alias input field 1811. For example, the user may name the basket Best_Best_Strategy_Platform. In one implementation, the user may associate the basket with an account (e.g., a client account) using the Account selection box 1812. In one implementation, the user may paste instrument data (e.g., transactions) from a different location (e.g., from another basket, portfolio optimizer product, spreadsheet, and/or the like) using the Paste button 1813. In one implementation, the user may append instrument data to an existing list of instrument data using the Append button 1814. If the user wishes to delete existing instrument data, the user may do so using the Clear button 1815.

If the user is satisfied with the basket data, the user may upload the basket using the Upload button 1816. In one implementation, the WORKFLOW OPTIMIZER may validate and save basket data, and may map instruments to identifiers recognized by the WORKFLOW OPTIMIZER at 1820. In one implementation, basket contents may be displayed as illustrated in 1830. In one implementation, if there are invalid instruments in the basket (e.g., invalid instrument 1832), the user may delete the invalid instruments using the Delete Invalids button 1817. In one implementation, the user may add transactions to the basket (e.g., using Add Transaction button 1841), move transactions (e.g., using Move Transaction button 1842), and/or delete transactions (e.g., using Delete Transaction button 1843). In one implementation, the user may delete the basket (e.g., using the Delete Basket button 1844), and/or append data from another basket to the basket (e.g., using the Append Basket button).

FIGS. 19A and 19B show a screen shot diagram illustrating maintaining quote data in one embodiment of the WORKFLOW OPTIMIZER. As illustrated in FIGS. 19A and 19B, quote data maintained by the WORKFLOW OPTIMIZER may include the identity of the broker 1905, the quoted price 1910, the date on which the quote was requested 1915, the time at which the quote was requested 1920, the status of the quote 1925 (e.g., received, rejected, and/or the like), the identity of the user who entered the quote 1930, and/or the like. Historical data regarding quotes may be maintained (e.g., for each broker) and displayed as illustrated in 1940. In one implementation, the user may add comments regarding quotes using the quote comment input field 1935.

### WORKFLOW OPTIMIZER Controller

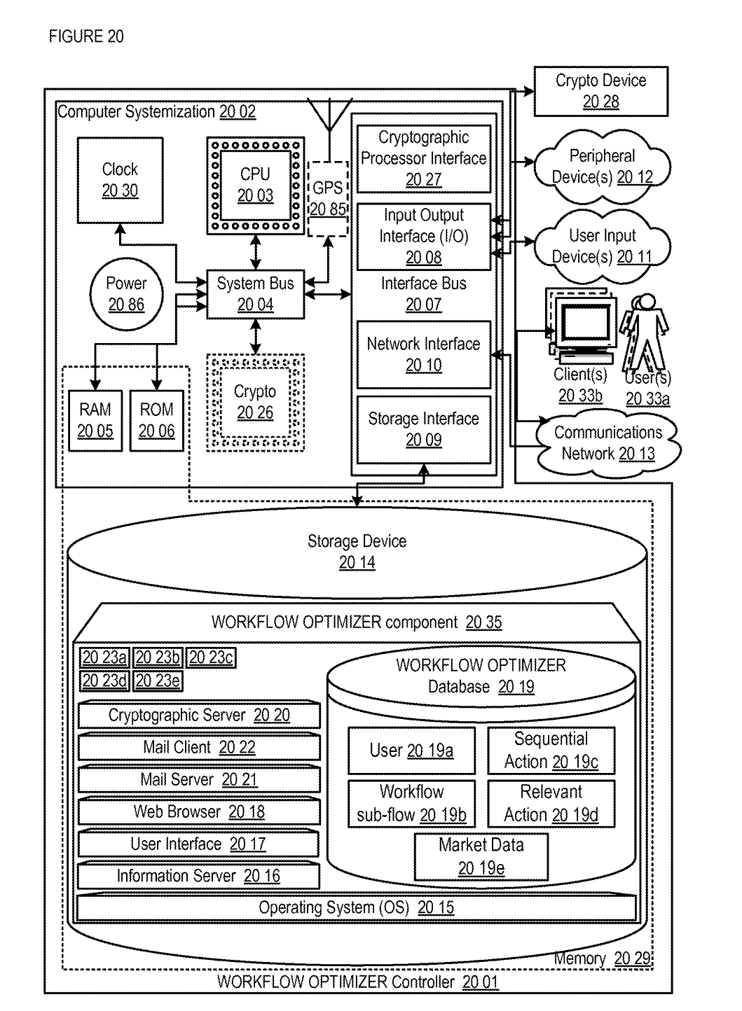

FIG. 20 illustrates inventive aspects of a WORKFLOW OPTIMIZER controller 2001 in a block diagram. In this embodiment, the WORKFLOW OPTIMIZER controller 2001 may serve to aggregate, process, store, search, serve, identify, instruct, generate, match, and/or facilitate interactions with a computer through a variety of information technologies, and/or other related data.

Typically, users, which may be people and/or other systems, may engage information technology systems (e.g., computers) to facilitate information processing. In turn, computers employ processors to process information; such processors 2003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the WORKFLOW OPTIMIZER controller 2001 may be connected to and/or communicate with entities such as, but not limited to: one or more users from user input devices 2011; peripheral devices 2012; an optional cryptographic processor device 2028; and/or a communications network 2013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The WORKFLOW OPTIMIZER controller 2001 may be based on computer systems that may comprise, but are not limited to, components such as: a computer systemization 2002 connected to memory 2029.

### Computer Systemization

A computer systemization 2002 may comprise a clock 2030, central processing unit (“CPU(s)” and/or “processor(s)” (these terms are used interchangeable throughout the disclosure unless noted to the contrary)) 2003, a memory 2029 (e.g., a read only memory (ROM) 2006, a random access memory (RAM) 2005, etc.), and/or an interface bus 2007, and most frequently, although not necessarily, are all interconnected and/or communicating through a system bus 2004 on one or more (mother)board(s) 2002 having conductive and/or otherwise transportive circuit pathways through which instructions (e.g., binary encoded signals) may travel to effect communications, operations, storage, etc. Optionally, the computer systemization may be connected to an internal power source 2086. Optionally, a cryptographic processor 2026 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the WORKFLOW OPTIMIZER controller and beyond through various interfaces. Should processing requirements dictate a greater amount speed and/or capacity, distributed processors (e.g., Distributed WORKFLOW OPTIMIZER), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the WORKFLOW OPTIMIZER may be achieved by implementing a microcontroller such as CAST's R8051XC2 microcontroller; Intel's MCS 51 (i.e., 8051 microcontroller); and/or the like. Also, to implement certain features of the WORKFLOW OPTIMIZER, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the WORKFLOW OPTIMIZER component collection (distributed or otherwise) and/or features may be implemented via the microprocessor and/or via embedded components; e.g., via ASIC, coprocessor, DSP, FPGA, and/or the like. Alternately, some implementations of the WORKFLOW OPTIMIZER may be implemented with embedded components that are configured and used to achieve a variety of features or signal processing.

Depending on the particular implementation, the embedded components may include software solutions, hardware solutions, and/or some combination of both hardware/software solutions. For example, WORKFLOW OPTIMIZER features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the WORKFLOW OPTIMIZER features. A hierarchy of programmable interconnects allow logic blocks to be interconnected as needed by the WORKFLOW OPTIMIZER system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the WORKFLOW OPTIMIZER may be developed on regular FPGAs and then migrated into a fixed version that more resembles ASIC implementations. Alternate or coordinating implementations may migrate WORKFLOW OPTIMIZER controller features to a final ASIC instead of or in addition to FPGAs. Depending on the implementation all of the aforementioned embedded components and microprocessors may be considered the “CPU” and/or “processor” for the WORKFLOW OPTIMIZER.

### Power Source

The power source 2086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2086 is connected to at least one of the interconnected subsequent components of the WORKFLOW OPTIMIZER thereby providing an electric current to all subsequent components. In one example, the power source 2086 is connected to the system bus component 2004. In an alternative embodiment, an outside power source 2086 is provided through a connection across the I/O 2008 interface. For example, a USB and/or IEEE 1394 connection carries both data and power across the connection and is therefore a suitable source of power.

### Interface Adapters

Interface bus(ses) 2007 may accept, connect, and/or communicate to a number of interface adapters, conventionally although not necessarily in the form of adapter cards, such as but not limited to: input output interfaces (I/O) 2008, storage interfaces 2009, network interfaces 2010, and/or the like. Optionally, cryptographic processor interfaces 2027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2009 may accept, communicate, and/or connect to a number of storage devices such as, but not limited to: storage devices 2014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2010 may accept, communicate, and/or connect to a communications network 2013. Through a communications network 2013, the WORKFLOW OPTIMIZER controller is accessible through remote clients 2033b (e.g., computers with web browsers) by users 2033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed WORKFLOW OPTIMIZER), architectures may similarly be employed to pool, load balance, and/or otherwise increase the communicative bandwidth required by the WORKFLOW OPTIMIZER controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2010 may be used to engage with various communications network types 2013. For example, multiple network interfaces may be employed to allow for the communication over broadcast, multicast, and/or unicast networks.

Input Output interfaces (I/O) 2008 may accept, communicate, and/or connect to user input devices 2011, peripheral devices 2012, cryptographic processor devices 2028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2011 may be card readers, dongles, finger print readers, gloves, graphics tablets, joysticks, keyboards, mouse (mice), remote controls, retina readers, trackballs, trackpads, and/or the like.

Peripheral devices 2012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the WORKFLOW OPTIMIZER controller may be embodied as an embedded, dedicated, and/or monitor-less (i.e., headless) device, wherein access would be provided over a network interface connection.

Cryptographic units such as, but not limited to, microcontrollers, processors 2026, interfaces 2027, and/or devices 2028 may be attached, and/or communicate with the WORKFLOW OPTIMIZER controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2029. However, memory is a fungible technology and resource, thus, any number of memory embodiments may be employed in lieu of or in concert with one another. It is to be understood that the WORKFLOW OPTIMIZER controller and/or a computer systemization may employ various forms of memory 2029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2029 will include ROM 2006, RAM 2005, and a storage device 2014. A storage device 2014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2029 may contain a collection of program and/or database components and/or data such as, but not limited to: operating system component(s) 2015 (operating system); information server component(s) 2016 (information server); user interface component(s) 2017 (user interface); Web browser component(s) 2018 (Web browser); database(s) 2019; mail server component(s) 2021; mail client component(s) 2022; cryptographic server component(s) 2020 (cryptographic server); the WORKFLOW OPTIMIZER component(s) 2035; and/or the like (i.e., collectively a component collection). These components may be stored and accessed from the storage devices and/or from storage devices accessible through an interface bus. Although non-conventional program components such as those in the component collection, typically, are stored in a local storage device 2014, they may also be loaded and/or stored in memory such as: peripheral devices, RAM, remote storage facilities through a communications network, ROM, various forms of memory, and/or the like.

### Operating System

The operating system component 2015 is an executable program component facilitating the operation of the WORKFLOW OPTIMIZER controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the WORKFLOW OPTIMIZER controller to communicate with other entities through a communications network 2013. Various communication protocols may be used by the WORKFLOW OPTIMIZER controller as a subcarrier transport mechanism for interaction, such as, but not limited to: multicast, TCP/IP, UDP, unicast, and/or the like.

### Information Server

An information server component 2016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the WORKFLOW OPTIMIZER controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the WORKFLOW OPTIMIZER database 2019, operating systems, other program components, user interfaces, Web browsers, and/or the like.

Access to the WORKFLOW OPTIMIZER database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the WORKFLOW OPTIMIZER. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the WORKFLOW OPTIMIZER as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2018 is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the WORKFLOW OPTIMIZER enabled nodes. The combined application may be nugatory on systems employing standard Web browsers.

### Mail Server

A mail server component 2021 is a stored program component that is executed by a CPU 2003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the WORKFLOW OPTIMIZER.

Access to the WORKFLOW OPTIMIZER mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2022 is a stored program component that is executed by a CPU 2003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2020 is a stored program component that is executed by a CPU 2003, cryptographic processor 2026, cryptographic processor interface 2027, cryptographic processor device 2028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the WORKFLOW OPTIMIZER may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the WORKFLOW OPTIMIZER component to engage in secure transactions if so desired. The cryptographic component facilitates the secure accessing of resources on the WORKFLOW OPTIMIZER and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The WORKFLOW OPTIMIZER Database

The WORKFLOW OPTIMIZER database component 2019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the WORKFLOW OPTIMIZER database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the WORKFLOW OPTIMIZER database is implemented as a data-structure, the use of the WORKFLOW OPTIMIZER database 2019 may be integrated into another component such as the WORKFLOW OPTIMIZER component 2035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

A user table 2019a includes fields such as, but not limited to: user_ID, user_name, and/or the like. The user table may support and/or track multiple entity accounts on a WORKFLOW OPTIMIZER. A workflow sub-flow table 2019b includes fields such as, but not limited to: workflow_sub-flow_ID, workflow_sub-flow_name, and/or the like. The workflow sub-flow table may support and/or track various workflow sub-flows that a user may complete as part of an overall workflow on a WORKFLOW OPTIMIZER. A sequential action table 2019c includes fields such as, but not limited to: sequential_action_ID, sequential_action_name, sequential_action_icon, sequential_action_order, and/or the like. The sequential action table may support and/or track various sequential actions that a user may complete as part of a workflow sub-flow on a WORKFLOW OPTIMIZER. A relevant action table 2019d includes fields such as, but not limited to: relevant_action_ID, relevant_action_name, relevant_action_icon, relevant_action_position, and/or the like. The relevant action table may support and/or track various relevant actions that a user may complete as part of a workflow sub-flow on a WORKFLOW OPTIMIZER. In one implementation, the information in tables 2019b-2019d may be used to construct and display user interface ribbons in a WORKFLOW OPTIMIZER. A market data table 2019e includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the WORKFLOW OPTIMIZER database may interact with other database systems. For example, employing a distributed database system, queries and data access by search WORKFLOW OPTIMIZER component may treat the combination of the WORKFLOW OPTIMIZER database, an integrated data security layer database as a single database entity.

In one embodiment, user programs may contain various user interface primitives, which may serve to update the WORKFLOW OPTIMIZER. Also, various accounts may require custom database tables depending upon the environments and the types of clients the WORKFLOW OPTIMIZER may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2019a-e. The WORKFLOW OPTIMIZER may be configured to keep track of various settings, inputs, and parameters via database controllers.

The WORKFLOW OPTIMIZER database may communicate to and/or with other components in a component collection, including itself, and/or facilities of the like. Most frequently, the WORKFLOW OPTIMIZER database communicates with the WORKFLOW OPTIMIZER component, other program components, and/or the like. The database may contain, retain, and provide information regarding other nodes and data.

### The WORKFLOW OPTIMIZERs

The WORKFLOW OPTIMIZER component 2035 is a stored program component that is executed by a CPU. In one embodiment, the WORKFLOW OPTIMIZER component incorporates any and/or all combinations of the aspects of the WORKFLOW OPTIMIZER that was discussed in the previous figures. As such, the WORKFLOW OPTIMIZER affects accessing, obtaining and the provision of information, services, transactions, and/or the like across various communications networks.

The WORKFLOW OPTIMIZER component transforms user action request input via various WORKFLOW OPTIMIZER components into updated incremental container user interface output, and/or the like, and enables use of the WORKFLOW OPTIMIZER. In one embodiment, the WORKFLOW OPTIMIZER component 2035 takes inputs (e.g., user action 320, and/or the like), and transforms the inputs via various components (e.g., BV 2023a, PRT 2023b, RFQ 2023c, BE 2023d, POT 2023e, and/or the like), into outputs (e.g., user action request 322, information request 324, information response 326, user progress data 328, sequential actions data 330, relevant actions data 332, updated UI ribbon response 334, updated UI ribbon 336, and/or the like), as shown in the figures and throughout the specification.

The WORKFLOW OPTIMIZER component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools, Prototype; script.aculo.us, Simple Object Access Protocol (SOAP); SWFObject; Yahoo! User Interface; and/or the like), WebObjects, and/or the like. In one embodiment, the WORKFLOW OPTIMIZER server employs a cryptographic server to encrypt and decrypt communications. The WORKFLOW OPTIMIZER component may communicate to and/or with other components in a component collection, including itself, and/or facilities of the like. Most frequently, the WORKFLOW OPTIMIZER component communicates with the WORKFLOW OPTIMIZER database, operating systems, other program components, and/or the like. The WORKFLOW OPTIMIZER may contain, communicate, generate, obtain, and/or provide program component, system, user, and/or data communications, requests, and/or responses.

### Distributed WORKFLOW OPTIMIZERs

The structure and/or operation of any of the WORKFLOW OPTIMIZER node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the WORKFLOW OPTIMIZER controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xav.com/perl/site/lib/SOAP/Parser.html
http://publib.boulder.ibm.com/Infocenter/tivihelp/v2r1/
index.jsp?topic=/com.ibm.IBMDI.doc/referenceguide295.htm

and other parser implementations:

http://publib.boulder.ibm.com/infocenter/tivihelp/v2r1/
index.jsp?topic=/com.ibm.IBMDI.doc/referenceguide259.htm

all of which are hereby expressly incorporated by reference.

In order to address various issues and improve over previous works, the application is directed to APPARATUSES, METHODS AND SYSTEMS FOR AN INCREMENTAL CONTAINER USER INTERFACE WORKFLOW OPTIMIZER. The entirety of this application (including the Cover Page, Title, Headings, Field, Background, Summary, Brief Description of the Drawings, Detailed Description, Claims, Abstract, Figures, Appendices, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a WORKFLOW OPTIMIZER individual and/or enterprise user, database configuration and/or relational model, data type, data transmission and/or network framework, syntax structure, and/or the like, various embodiments of the WORKFLOW OPTIMIZER, may be implemented that enable a great deal of flexibility and customization. For example, aspects of the WORKFLOW OPTIMIZER may be adapted for credit card processing, loan processing, training, and/or the like. While various embodiments and discussions of the WORKFLOW OPTIMIZER have been directed to portfolio management, however, it is to be understood that the embodiments described herein may be readily configured and/or customized for a wide variety of other applications and/or implementations.

What is claimed is:

1. A workflow optimization processor-implemented method, comprising:
receiving an indication of a user's progress in an overall workflow;
determining via a processor a current workflow sub-flow based on the user's progress;
determining via the processor sequential actions sufficient to complete the current workflow sub-flow;
determining via the processor relevant actions that are applicable to the current workflow sub-flow and that are not sequential actions; and
displaying an incremental container user interface for the current workflow sub-flow wherein:
a first part of the incremental container user interface comprises user interface components in a sequential order corresponding to the sequential actions;
a second part of the incremental container user interface comprises user interface components corresponding to the relevant actions.

2. The method of claim 1, wherein the incremental container user interface is a ribbon.

3. The method of claim 1, further comprising:
identifying a tracking index;
detecting a sequential workflow advancement upon determination of sequential actions sufficient to complete the current workflow sub-flow; and
calculating, in response to the sequential workflow advancement, a basket of assets to track the tracking index.

4. The method of claim 3, wherein the calculating is accelerated with a high performance computing facility.

5. The method of claim 3, further comprising:
generating a quote request for fulfillment by a financial institution;
providing the quote request to financial institutions;
obtaining responses to the quote requests from the financial institutions;
selecting a financial institution response to the quote request; and
effecting a trade execution with the financial institution based on the selected financial institution response.

6. A workflow optimization apparatus, comprising:
a memory;
a processor disposed in communication with said memory, and configured to issue a plurality of processing instructions stored in the memory, wherein the processor issues instructions to:
receive an indication of a user's progress in an overall workflow;
determine a current workflow sub-flow based on the user's progress;
determine sequential actions sufficient to complete the current workflow sub-flow;
determine relevant actions that are applicable to the current workflow sub-flow and that are not sequential actions; and
display an incremental container user interface for the current workflow sub-flow wherein:
a first part of the incremental container user interface comprises user interface components in a sequential order corresponding to the sequential actions;
a second part of the incremental container user interface comprises user interface components corresponding to the relevant actions.

7. The apparatus of claim 6, wherein the incremental container user interface is a ribbon.

8. The apparatus of claim 1, further comprising instructions to:
identify a tracking index;
detect a sequential workflow advancement upon determination of sequential actions sufficient to complete the current workflow sub-flow; and
calculate, in response to the sequential workflow advancement, a basket of assets to track the tracking index.

9. The apparatus of claim 8, wherein the calculating is accelerated with a high performance computing facility.

10. The apparatus of claim 8, further comprising instructions to:
generate a quote request for fulfillment by a financial institution;
provide the quote request to financial institutions;
obtain responses to the quote requests from the financial institutions;
select a financial institution response to the quote request; and
effect a trade execution with the financial institution based on the selected financial institution response.

11. A workflow optimization processor-readable physical medium storing processor-issuable-and-generated instructions to:
receive an indication of a user's progress in an overall workflow;
determine a current workflow sub-flow based on the user's progress;
determine sequential actions sufficient to complete the current workflow sub-flow;
determine relevant actions that are applicable to the current workflow sub-flow and that are not sequential actions; and
display an incremental container user interface for the current workflow sub-flow wherein:
a first part of the incremental container user interface comprises user interface components in a sequential order corresponding to the sequential actions;
a second part of the incremental container user interface comprises user interface components corresponding to the relevant actions.

12. The apparatus of claim 11, wherein the incremental container user interface is a ribbon.

13. The apparatus of claim 11, further comprising instructions to:
identify a tracking index;
detect a sequential workflow advancement upon determination of sequential actions sufficient to complete the current workflow sub-flow; and
calculate, in response to the sequential workflow advancement, a basket of assets to track the tracking index.

14. The apparatus of claim 13, wherein the calculating is accelerated with a high performance computing facility.

15. The apparatus of claim 13, further comprising instructions to:
generate a quote request for fulfillment by a financial institution;
provide the quote request to financial institutions;
obtain responses to the quote requests from the financial institutions;
select a financial institution response to the quote request; and
effect a trade execution with the financial institution based on the selected financial institution response.

16. A financial quote request guide processor-implemented method, comprising:
creating a financial quote request guide datastructure to store financial quote request guide state activities, wherein the states limit and require specified subsequent states, including:
obtaining a specified financial vehicle target from a source;
obtaining financial performance requirements to develop a target analog;
providing the specified target and performance requirements to a market vehicle basket item selector component;
obtaining a determined target analog basket from the market vehicle basket item selector;
obtaining specified quote targets;
generating an anonymized quote request to obtain the determined target analog basket, including:
removing source identifying information from the source;
sending the generated anonymized quote request to the quote targets;
obtaining quotes from the quote targets;
generating a purchase request for market vehicles specified in the determined market analog basket;
obtaining purchase statistics for purchased market vehicles;
storing the datastructure.

17. The method of claim 16, wherein the determining of the target analog basket of market vehicles is constrained by the obtained financial performance requirements.

18. The method of claim 16, further comprising modifying basket constituent market vehicles in the obtained determined target analog basket.

19. The method of claim 16, wherein generating an anonymized quote request further includes obfuscating quantities of basket constituent market vehicles.

20. The method of claim 19, wherein quantities of constituent market vehicles are rounded up to a higher lot size.

21. The method of claim 16, further comprising obtaining modifications to the target analog basket based on the obtained quotes.

22. The method of claim 6, further comprising comparing the obtained quotes to the obtained purchase statistics.

23. The method of claim 16, further comprising:
retrieving the stored datastructure;
instantiating the retrieved datastructure;
reviewing the instantiated datastructure;
modifying the instantiated datastructure;
transacting based on the modified instantiated datastructure.

24. A workflow optimization system, comprising means to:
means to receive an indication of a user's progress in an overall workflow;
means to determine a current workflow sub-flow based on the user's progress;
means to determine sequential actions sufficient to complete the current workflow sub-flow;
means to determine relevant actions that are applicable to the current workflow sub-flow and that are not sequential actions; and
means to display an incremental container user interface for the current workflow sub-flow wherein:
a first part of the incremental container user interface comprises user interface components in a sequential order corresponding to the sequential actions;
a second part of the incremental container user interface comprises user interface components corresponding to the relevant actions.
